(19) United States
(12) Patent Application Publication
(10) Pub. No.: US 2026/0292905 A1
(43) Pub. Date: Sep. 24, 2026

(54) Methods and Signaling Procedures for Direct End-to-End PC5 Link Support in Layer 2 of UE-to-UE Relay

(71) Applicant: Apple Inc., Cupertino, CA (US)

(72) Inventors: Zhibin Wu, Los Altos (CA); Alexander Sirotkin, Hod Hasharon, IL (US); Peng Cheng, Beijing (CN); Sudeep Manithara Vamanan, Uttenreuth (DE); Naveen Kumar R. Palle Venkata, San Diego, CA (US); Yuqin Chen, Beijing (CN); Fangli Xu, Beijing (CN); Haijing Hu, Los Gatos, CA (US); Ping-Heng Kuo, London (GB)

(21) Appl. No.: 19/472,968

(22) PCT Filed: May 9, 2023
(86) PCT No.: PCT/CN2023/093031

§ 371 Date: Oct. 6, 2025

(51) Int. Cl. H04W 76/14; H04W 76/11; H04W 88/04

(52) U.S. Cl. CPC H04W 76/14; H04W 76/11; H04W 88/04

(57) ABSTRACT

Signaling procedures may be established to provide support for direct end-to-end PC5 link establishment in Layer 2 (L2) of a UE-to-UE relay. According to a first option, the direct end-to-end L2 PC5 link between two remote UEs (communicating via a relay UE) in not identified by conventional L2 addresses, and one or more local L2 identifiers specific to the end-to-end L2 PC5 link may be used instead. According to a second option, the L2 IDs identifying the end-to-end L2 PC5 link may be the same L2 ID(s) used by the remote UEs for their respective PC5 links to the relay UE. According to a third option, L2 IDs, different from the respective L2 IDs used by the remote UEs for their respective PC5 links to the relay UE, may be established specifically to identify the end-to-end L2 PC5 link. Solutions addressing each option may include RRC procedures and/or PC5-S procedures for different direct end-to-end L2 PC5 link establishment approaches.

### FIELD OF THE INVENTION

The present application relates to wireless communications, including signaling procedures for end-to-end PC5 link support in Layer 2 UE-to-UE relay during/in wireless sidelink communications, e.g., during/in 5G NR sidelink communications.

### DESCRIPTION OF THE RELATED ART

Wireless communication systems are rapidly growing in usage. In recent years, wireless devices such as smart phones and tablet computers have become increasingly sophisticated. In addition to supporting telephone calls, many mobile devices (i.e., user equipment devices or UEs) now provide access to the internet, email, text messaging, and navigation using the global positioning system (GPS), and are capable of operating sophisticated applications that utilize these functionalities. Additionally, there exist numerous different wireless communication technologies and standards. Some examples of wireless communication standards include LTE, LTE Advanced (LTE-A), HSPA, 3GPP2, IEEE 802.11 (WLAN or Wi-Fi), IEEE 802.16 (WiMAX), BLUETOOTH™, etc. A current telecommunications standard moving beyond previous standards is called 5th generation mobile networks or 5th generation wireless systems, referred to as 3GPP NR (otherwise known as 5G-NR or NR-5G for 5G New Radio, also simply referred to as NR). NR proposes a higher capacity for a higher density of mobile broadband users, also supporting device-to-device, ultra-reliable, and massive machine communications, as well as lower latency and lower battery consumption, than LTE standards.

One aspect of wireless communication systems, including NR cellular wireless communications, involves device-to-device communications, with select devices at times operating as relays for aiding such communications. Improvements in the field are desired.

### SUMMARY OF THE INVENTION

Embodiments are presented herein of, inter alia, of methods and signaling procedures for end-to-end sidelink (SL), e.g., PC5 link, support in Layer 2 UE-to-UE relays, during wireless sidelink communications, for example during 3GPP New Radio (NR) sidelink communications. Embodiments are further presented herein for wireless communication systems containing at least wireless communication devices or user equipment devices (UEs) and/or base stations communicating with each other within the wireless communication systems.

Signaling procedures may be established in support of an end-to-end PC5 link establishment in Layer 2 (L2) of a UE-to-UE relay. Three options are considered. According to a first option, no conventional L2 identifiers (IDs) (or addresses) may be used to identify the end-to-end PC5 link between two remote UEs (communicating via a relay UE), in view of the L2 end-to-end PC5 link being considered a virtual link with no need to use L2 IDs (or addresses) over the air. Instead, local L2 identifiers (or addresses) specifically identifying the direct end-to-end L2 PC5 link may be used. According to a second option, the L2 IDs (or addresses) used for the direct end-to-end L2 PC5 link between the remote UEs may be the same L2 ID(s) (or addresses) used by the remote UEs for their respective PC5 links with the relay UE. According to a third option, conventional L2 IDs (or addresses), different from the respective L2 IDs (or addresses) used by the remote UEs for their respective PC5 links with the relay UE, may be established specifically to identify the end-to-end L2 PC5 link. Solutions addressing each option may include RRC procedures and/or PC5-S procedures for a variety of different direct end-to-end L2 PC5 link establishment approaches.

Accordingly, a first direct sidelink communication link may be established between a relay device and a first remote device, and a second direct sidelink communication link may be established between the relay device and a second remote device. The relay device may assist in establishing a direct end-to-end L2 sidelink communication link between the first remote device and the second remote device. That is, a direct end-to-end L2 sidelink communication link between the first remote device and the second remote device may be established via the relay device. Communication may then be enabled between the first remote device and the second remote device via the first direct sidelink communication link and the second direct sidelink communication link based on the established direct end-to-end L2 sidelink communication link.

### Use of Local L2 ID(s)

In some embodiments, establishing the direct end-to-end L2 sidelink communication link between the first remote device and the second remote device may include the relay device allocating a single local ID (or address) identifying the end-to-end L2 sidelink communication link, and sharing the single local ID (or address) with the first remote device and the second remote device.

In some embodiments, establishing the direct end-to-end L2 sidelink communication link between the first remote device and the second remote device may include the relay device allocating a first local ID (or address) representing the first remote device and a second local ID (or address) representing the second remote device, where the first local ID (or address) and the second local ID (or address) together identify the direct end-to-end L2 sidelink communication link, and the relay device sharing the first local ID and the second local ID with both the first remote device and the second remote device.

In some embodiments, establishing the direct end-to-end L2 sidelink communication link may include first remote device allocating a first local ID (or address) identifying the direct end-to-end L2 sidelink communication link for a first sidelink hop between the first remote device and the relay device, and the relay device allocating a second local ID (or address) identifying the end-to-end L2 sidelink communication link for a second sidelink hop between the relay device and the second remote device.

### Use of Conventional Layer 2 IDs

In some embodiments, establishing the direct end-to-end L2 sidelink communication link may include the relay device sharing, through first sidelink radio resource control (RRC) signaling, a first L2 address (or ID) of the first remote device with the second remote device, and the relay device further sharing, through second sidelink RRC signaling, a second L2address (or ID) of the second remote device with the first remote device. The first L2 address (or ID) and the second L2 address (or ID) may together identify the direct end-to-end L2 sidelink communication link, while the first remote device may also use the first L2 address (or ID) for sidelink communications with the relay device, and the second remote device may also use the second L2 address (or ID) for sidelink communications with the relay device.

In some embodiments, establishing the direct end-to-end L2 sidelink communication link may include the relay device receiving from the first remote device a direct end-to-end link establishment request that includes a sidelink relay adaptation protocol (SRAP) header that contains an indication that the first remote device cannot identify the direct end-to-end Layer 2 sidelink communication link. The relay device may update the SRAP header with one or more identifiers identifying the direct end-to-end Layer 2 sidelink communication link, and forward the request with the updated SRAP header to the second remote device. The indication (that the first remote device cannot identify the direct end-to-end Layer 2 sidelink communication link) may include: a source device ID identifying the first remote device, a special target device ID indicating that a required target device ID associated with the direct end-to-end Layer 2 sidelink communication link is unknown to the first remote device, and a bearer ID field indicating that the request is an end-to-end sidelink signal radio bearer 0(SL-SRB 0 ) message. The source device ID and the required target device ID may together identify the direct end-to-end Layer 2 sidelink communication link. The request may be received by the relay device in an SRAP protocol data unit (PDU), and the relay device may determine, based at least on a bearer ID field in the SRAP header indicating SL-SRB0, that the SRAP PDU contains a message aimed at establishing a pending direct end-to-end Layer 2 sidelink communication link. The relay device may then update the SRAP header to include a target device ID identifying the second remote device.

In some embodiments, establishing the direct end-to-end L2 sidelink communication link may include the relay device triggering upper layers to share a first L2 ID (or address) that identifies the first remote device, and to further share a second Layer 2 ID (or address) that identifies the second remote device. The relay device may then share the second Layer 2 ID (or address) with the first remote device via a first sidelink-signaling-protocol-stack (PC5-S) procedure, and may further share the first Layer 2 ID (or address) with the second remote device via a second PC5-S procedure. The first L2 ID (or address) and the second L2 ID (or address) may together identify the direct end-to-end L2 sidelink communication link, while the first remote device may also use the first L2 ID (or address) for sidelink communications with the relay device, and the second remote device may also use the second L2 ID (or address) for sidelink communications with the relay device.

### Use of New Layer 2 IDs Specific to the Direct End-to-end L2 PC5 Link

In some embodiments, establishing the direct end-to-end L2 sidelink communication link may include the relay device sharing a second Layer 2 ID with the first remote device via a first PC5-S procedure, and further sharing a first Layer 2 ID with the second remote device via a second PC5-S procedure. The first Layer 2 ID and the second Layer 2 ID may be defined by upper layers specifically for the direct end-to-end Layer 2 sidelink communication link.

### Additional Considerations

Sidelink relay radio link control (RLC) channel support may be specifically configured for the end-to-end PC5-S procedures used in establishing the direct end-to-end L2 sidelink communication link. In some embodiments, configuring the sidelink RLC channel support may include using a single default configuration for sidelink signal radio bearers (SL-SRBs) with fixed default logical channel identifiers (LCIDs) in the first direct sidelink communication link and in the second direct sidelink communication link. In some embodiments, configuring the sidelink RLC channel support may include the relay device configuring, via respective sidelink radio resource control (RRC) signaling, sidelink relay RLC channels to support end-to-end SL-SRBs in the first direct sidelink communication link and in the second direct sidelink communication link. In some embodiments, configuring the sidelink RLC channel support may include the first remote device configuring, via first sidelink RRC signaling, a first sidelink RLC channel used in the first direct sidelink communication link, and further configuring, via second sidelink RRC signaling, a second sidelink RLC channel used in the second direct sidelink communication link.

In some embodiments, establishing the direct end-to-end L2 sidelink communication link between the first remote device and the second remote device may include using one or more sidelink RRC procedures that take place prior to initiating establishment of the direct end-to-end L2 sidelink communication link. The first remote device (e.g., source remote device) may transmit a request to initiate establishment of the direct end-to-end L2 sidelink communication link, subsequent to allocation of one or more identifiers that identify the direct end to end L2 sidelink communication link.

Note that the techniques described herein may be implemented in and/or used with a number of different types of devices, including but not limited to, base stations, access points, cellular phones, portable media players, tablet computers, wearable devices, and various other computing devices.

This Summary is intended to provide a brief overview of some of the subject matter described in this document. Accordingly, it will be appreciated that the above-described features are merely examples and should not be construed to narrow the scope or spirit of the subject matter described herein in any way. Other features, aspects, and advantages of the subject matter described herein will become apparent from the following Detailed Description, Figures, and Claims.

### BRIEF DESCRIPTION OF THE DRAWINGS

FIG. 1 illustrates an exemplary (and simplified) wireless communication system, according to some embodiments;

FIG. 2 illustrates an exemplary base station in communication with an exemplary wireless user equipment (UE) device, according to some embodiments;

FIG. 3 illustrates an exemplary block diagram of a UE, according to some embodiments;

FIG. 4 illustrates an exemplary block diagram of a base station, according to some embodiments;

FIG. 5 shows an exemplary simplified block diagram illustrative of cellular communication circuitry, according to some embodiments;

FIG. 6 shows an exemplary diagram illustrating a basic scenario of UE-to-UE (U2U) sidelink (PC5) communications between a single source UE and a single target UE via a single relay;

FIG. 7 shows an exemplary diagram illustrating a multiplex scenario of UE-to-UE (U2U) sidelink (PC5) communications between a single source UE and multiple target UEs via a single relay;

FIG. 8 shows an exemplary diagram illustrating a multiplex scenario of UE-to-UE (U2U) sidelink (PC5) communications between multiple source UEs and a single target UE via a single relay;

FIG. 9 shows an exemplary diagram illustrating a multi-relay scenario of UE-to-UE (U2U) sidelink (PC5) communications between a single source UE and multiple target UEs via corresponding relays;

FIG. 10 shows an exemplary timing diagram of a Layer 3 UE-to-UE (U2U) setup procedure;

FIG. 11 shows an exemplary timing diagram of a possible Layer 2 UE-to-UE (U2U) setup procedure requiring additional end-to-end PC5 link setup steps in a multi-relay scenario;

FIG. 12 shows an exemplary communication diagram of a Layer 2 UE-to-UE (U2U) setup procedure via a relay UE with distinct end-to-end connection establishment for unicast mode of communication;

FIG. 13 shows an exemplary system diagram illustrating device communication layers, including sidelink relay adaptation layer (SRAP), used for Layer 2 UE-to-UE (U2U) end-to-end PC5 signaling;

FIG. 14 shows a first exemplary timing diagram illustrating signaling flow details for establishing a direct end-to-end Layer 2 PC5 link via a relay, according to some embodiments;

FIG. 15 shows a second exemplary timing diagram illustrating signaling flow details for establishing a direct end-to-end Layer 2 PC5 link via a relay, according to some embodiments;

FIG. 16 shows a third exemplary timing diagram illustrating signaling flow details for establishing a direct end-to-end Layer 2 PC5 link via a relay, according to some embodiments;

FIG. 17 shows a fourth exemplary timing diagram illustrating signaling flow details for establishing a direct end-to-end Layer 2 PC5 link via a relay, according to some embodiments;

FIG. 18 shows a fifth exemplary timing diagram illustrating signaling flow details for establishing a direct end-to-end Layer 2 PC5 link via a relay, according to some embodiments;

FIG. 19 shows an exemplary table of various example parameter values used for SL-U2U-RLC AM mode communications, according to some embodiments; and

FIG. 20 shows an exemplary flow diagram for sidelink communications between two remote devices via a relay device, according to some embodiments.

While features described herein are susceptible to various modifications and alternative forms, specific embodiments thereof are shown by way of example in the drawings and are herein described in detail. It should be understood, however, that the drawings and detailed description thereto are not intended to be limiting to the particular form disclosed, but on the contrary, the intention is to cover all modifications, equivalents and alternatives falling within the spirit and scope of the subject matter as defined by the appended claims.

### DETAILED DESCRIPTION OF THE EMBODIMENTS

### Acronyms

Various acronyms are used throughout the present application. Definitions of the most prominently used acronyms that may appear throughout the present application are provided below:
5GMM: 5G Mobility Management
AF: Application Function
AMF: Access and Mobility Management Function
AMR: Adaptive Multi-Rate
AP: Access Point
APN: Access Point Name
APR: Applications Processor
BS: Base Station
BSR: Buffer Status Report
BSSID: Basic Service Set Identifier
CA: Carrier Aggregation
CBG: Code Block Group
CBRS: Citizens Broadband Radio Service
CBSD: Citizens Broadband Radio Service Device
CBW: Channel Bandwidth
CCA: Clear Channel Assessment
CMR: Change Mode Request
CORESET: Control Resource Set
CS: Circuit Switched
CSI: Channel State Information
DC: Dual Connectivity
DCI: Downlink Control Information
DL: Downlink (from BS to UE)
DMRS: Demodulation Reference Signal
DN: Data Network
DRB: Data Radio Bearer
DSDS: Dual SIM Dual Standby
DYN: Dynamic
EDCF: Enhanced Distributed Coordination Function
eSNPN: Equivalent Standalone Non-Public Network
ETSI: European Telecommunications Standards Institute
FDD: Frequency Division Duplexing
FT: Frame Type
GAA: General Authorized Access
GPRS: General Packet Radio Service
GSM: Global System for Mobile Communication
GTP: GPRS Tunneling Protocol
HPLMN: Home Public Land Mobile Network
IC: In Coverage
ICBM: Inter-Cell Beam Management
IMS: Internet Protocol Multimedia Subsystem
IOT: Internet of Things
IP: Internet Protocol
ITS: Intelligent Transportation Systems
IUC: Inter-UE Coordination
LAN: Local Area Network
LBT: Listen Before Talk
LCID: Logical Channel ID
LCS: Location Services
LMF: Location Management Function
LPP: LTE Positioning Protocol
LQM: Link Quality Metric
LTE: Long Term Evolution
MCC: Mobile Country Code
MCS: Modulation and Coding Scheme
MNO: Mobile Network Operator
MO-LR: Mobile Originated Location Request
MT-LR: Mobile-Terminated Location Request
NAS: Non-Access Stratum
NDI: New Data Indicator
NF: Network Function
NG: Next Generation
NG-RAN: Next Generation Radio Access Network
NID: Network Identifier
NMF: Network Identifier Management Function
NPN: Non-Public (cellular) Network
NRF: Network Repository Function
NSI: Network Slice Instance
NSSAI: Network Slice Selection Assistance Information
OLPC: Open Loop Power Control
OOC: Out Of Coverage
PAL: Priority Access Licensee
PBCH: Physical Broadcast Channel
PDCP: Packet Data Convergence Protocol
PDN: Packet Data Network
PDU: Protocol Data Unit
PGW: PDN Gateway
PLMN: Public Land Mobile Network
ProSe: Proximity Services
PRS: Positioning Reference Signal
PSCCH: Physical Sidelink Control Channel
PSFCH: Physical Sidelink Feedback Channel
PSSCH: Physical Sidelink Shared Channel
PSD: Power Spectral Density
PSS: Primary Synchronization Signal
PT: Payload Type
PTRS: Phase Tracking Reference Signal
PUCCH: Physical Uplink Control Channel
QBSS: Quality of Service Enhanced Basic Service Set
QI: Quality Indicator
RA: Registration Accept
RAN: Radio Access Network
RAT: Radio Access Technology
RE: Resource Element
RF: Radio Frequency
RLC: Radio Link Control
RLM: Radio Link Monitoring
RNTI: Radio Network Temporary Identifier
ROHC: Robust Header Compression
RR: Registration Request
RRC: Radio Resource Control
RRM: Radio Resource Management
RS: Reference Signal
RSRP: Reference Signal Receive Power
RTP: Real-time Transport Protocol
RTT: Round Trip Time
RV: Redundancy Version
RX: Reception/Receive
SAS: Spectrum Allocation Server
SCI: Sidelink Control Information
SCCH: Sidelink Control Channel
SCS: Subcarrier Spacing
SD: Slice Descriptor
SI: System Information
SIB: System Information Block
SID: System Identification Number
SLPP: Sidelink Positioning Procedures
SIM: Subscriber Identity Module
SINR: Signal-To-Interference-Plus-Noise Ratio
SGW: Serving Gateway
SMF: Session Management Function
SNPN: Standalone Non-Public Network
SRAP: Sidelink Relay Adaptation Layer
SRB: Signal Radio Bearer
SRS: Sounding Reference Signal
SSB: Synchronization Signal Block
SSS: Secondary Synchronization Signal
SUPI: Subscription Permanent Identifier
TBS: Transport Block Size
TCP: Transmission Control Protocol
TDD: Time Division Duplexing
TDOA: Time Difference of Arrival
TDRA: Time Domain Resource Allocation
TPC: Transmit Power Control
TRP: Transmission/Reception Point
TX: Transmission/Transmit
UAC: Unified Access Control
UDM: Unified Data Management
UDR: User Data Repository
UE: User Equipment
UI: User Input
UL: Uplink (from UE to BS)
UMTS: Universal Mobile Telecommunication System
UPF: User Plane Function
URLLC: Ultra-Reliable Low-Latency Communication
URM: Universal Resources Management
URSP: UE Route Selection Policy
USIM: User Subscriber Identity Module
Wi-Fi: Wireless Local Area Network (WLAN) RAT based on the Institute of Electrical and Electronics Engineers' (IEEE) 802.11 standards
WLAN: Wireless LAN
ZP: Zero Power

### Terms

The following is a glossary of terms that may appear in the present application:

Memory Medium—Any of various types of memory devices or storage devices. The term “memory medium” is intended to include an installation medium, e.g., a CD-ROM, floppy disks, or tape device; a computer system memory or random access memory such as DRAM, DDR RAM, SRAM, EDO RAM, Rambus RAM, etc. ; a non-volatile memory such as a Flash, magnetic media, e.g., a hard drive, or optical storage; registers, or other similar types of memory elements, etc. The memory medium may comprise other types of memory as well or combinations thereof. In addition, the memory medium may be located in a first computer system in which the programs are executed, or may be located in a second different computer system which connects to the first computer system over a network, such as the Internet. In the latter instance, the second computer system may provide program instructions to the first computer system for execution. The term “memory medium” may include two or more memory mediums which may reside in different locations, e.g., in different computer systems that are connected over a network. The memory medium may store program instructions (e.g., embodied as computer programs) that may be executed by one or more processors.

Carrier Medium—a memory medium as described above, as well as a physical transmission medium, such as a bus, network, and/or other physical transmission medium that conveys signals such as electrical, electromagnetic, or digital signals.

Programmable Hardware Element—Includes various hardware devices comprising multiple programmable function blocks connected via a programmable interconnect. Examples include FPGAs (Field Programmable Gate Arrays), PLDs (Programmable Logic Devices), FPOAs (Field Programmable Object Arrays), and CPLDs (Complex PLDs). The programmable function blocks may range from fine grained (combinatorial logic or look up tables) to coarse grained (arithmetic logic units or processor cores). A programmable hardware element may also be referred to as “reconfigurable logic”.

Computer System (or Computer)—any of various types of computing or processing systems, including a personal computer system (PC), mainframe computer system, workstation, network appliance, Internet appliance, personal digital assistant (PDA), television system, grid computing system, or other device or combinations of devices. In general, the term “computer system” may be broadly defined to encompass any device (or combination of devices) having at least one processor that executes instructions from a memory medium.

User Equipment (UE) (or “UE Device”)—any of various types of computer systems devices which perform wireless communications. Also referred to as wireless communication devices, many of which may be mobile and/or portable. Examples of UE devices include mobile telephones or smart phones (e.g., iPhone™, Android™-based phones) and tablet computers such as iPad™, Samsung Galaxy™, etc., gaming devices (e.g. Sony PlayStation™, Microsoft XBox™, etc.), portable gaming devices (e.g., Nintendo DS™, PlayStation Portable™, Gameboy Advance™, iPod™), laptops, wearable devices (e.g. smart watch, smart glasses), PDAs, portable Internet devices, music players, data storage devices, or other handheld devices, unmanned aerial vehicles (e.g., drones) and unmanned aerial controllers, etc. Various other types of devices would fall into this category if they include Wi-Fi or both cellular and Wi-Fi communication capabilities and/or other wireless communication capabilities, for example over short-range radio access technologies (SRATs) such as BLUETOOTH™, etc. In general, the term “UE” or “UE device” may be broadly defined to encompass any electronic, computing, and/or telecommunications device (or combination of devices) which is capable of wireless communication and may also be portable/mobile.

Wireless Device (or wireless communication device)—any of various types of computer systems devices which performs wireless communications using WLAN communications, SRAT communications, Wi-Fi communications and the like. As used herein, the term “wireless device” may refer to a UE device, as defined above, or to a stationary device, such as a stationary wireless client or a wireless base station. For example, a wireless device may be any type of wireless station of an 802.11 system, such as an access point (AP) or a client station (UE), or any type of wireless station of a cellular communication system communicating according to a cellular radio access technology (e.g. 5G NR, LTE, CDMA, GSM), such as a base station or a cellular telephone, for example.

Communication Device—any of various types of computer systems or devices that perform communications, where the communications can be wired or wireless. A communication device can be portable (or mobile) or may be stationary or fixed at a certain location. A wireless device is an example of a communication device. A UE is another example of a communication device.

Base Station (BS)—The term “Base Station” has the full breadth of its ordinary meaning, and at least includes a wireless communication station installed at a fixed location and used to communicate as part of a wireless telephone system or radio system.

Processor—refers to various elements (e.g. circuits) or combinations of elements that are capable of performing a function in a device, e.g. in a user equipment device or in a cellular network device. Processors may include, for example: general purpose processors and associated memory, portions or circuits of individual processor cores, entire processor cores or processing circuit cores, processing circuit arrays or processor arrays, circuits such as ASICs (Application Specific Integrated Circuits), programmable hardware elements such as a field programmable gate array (FPGA), as well as any of various combinations of the above.

Channel—a medium used to convey information from a sender (transmitter) to a receiver. It should be noted that since characteristics of the term “channel” may differ according to different wireless protocols, the term “channel” as used herein may be considered as being used in a manner that is consistent with the standard of the type of device with reference to which the term is used. In some standards, channel widths may be variable (e.g., depending on device capability, band conditions, etc.). For example, LTE may support scalable channel bandwidths from 1.4 MHz to 20 MHz. In contrast, WLAN channels may be 22 MHz wide while Bluetooth channels may be 1 Mhz wide. Other protocols and standards may include different definitions of channels. Furthermore, some standards may define and use multiple types of channels, e.g., different channels for uplink or downlink and/or different channels for different uses such as data, control information, etc.

Band (or Frequency Band)—The term “band” has the full breadth of its ordinary meaning, and at least includes a section of spectrum (e.g., radio frequency spectrum) in which channels are used or set aside for the same purpose. Furthermore, “frequency band” is used to denote any interval in the frequency domain, delimited by a lower frequency and an upper frequency. The term may refer to a radio band or an interval of some other spectrum. A radio communications signal may occupy a range of frequencies over which (or where) the signal is carried. Such a frequency range is also referred to as the bandwidth of the signal. Thus, bandwidth refers to the difference between the upper frequency and lower frequency in a continuous band of frequencies. A frequency band may represent one communication channel or it may be subdivided into multiple communication channels. Allocation of radio frequency ranges to different uses is a major function of radio spectrum allocation. For example, in 5G NR, the operating frequency bands are categorized in two groups. More specifically, per 3GPP Release 15, frequency bands are designated for different frequency ranges (FR) and are defined as FR1 and FR2, with FR1 encompassing the 410 MHz-7125 MHz range and FR2 encompassing the 24250 MHz-52600 MHz range.

Wi-Fi—The term “Wi-Fi” has the full breadth of its ordinary meaning, and at least includes a wireless communication network or RAT that is serviced by wireless LAN (WLAN) access points and which provides connectivity through these access points to the Internet. Most modern Wi-Fi networks (or WLAN networks) are based on IEEE 802.11 standards and are marketed under the name “Wi-Fi”. A Wi-Fi (WLAN) network is different from a cellular network.

Automatically—refers to an action or operation performed by a computer system (e.g., software executed by the computer system) or device (e.g., circuitry, programmable hardware elements, ASICs, etc.), without user input directly specifying or performing the action or operation. Thus the term “automatically” is in contrast to an operation being manually performed or specified by the user, where the user provides input to directly perform the operation. An automatic procedure may be initiated by input provided by the user, but the subsequent actions that are performed “automatically” are not specified by the user, i.e., are not performed “manually”, where the user specifies each action to perform. For example, a user filling out an electronic form by selecting each field and providing input specifying information (e.g., by typing information, selecting check boxes, radio selections, etc.) is filling out the form manually, even though the computer system must update the form in response to the user actions. The form may be automatically filled out by the computer system where the computer system (e.g., software executing on the computer system) analyzes the fields of the form and fills in the form without any user input specifying the answers to the fields. As indicated above, the user may invoke the automatic filling of the form, but is not involved in the actual filling of the form (e.g., the user is not manually specifying answers to fields but rather they are being automatically completed). The present specification provides various examples of operations being automatically performed in response to actions the user has taken.

Approximately—refers to a value that is almost correct or exact. For example, approximately may refer to a value that is within 1 to 10 percent of the exact (or desired) value. It should be noted, however, that the actual threshold value (or tolerance) may be application dependent. For example, in some embodiments, “approximately” may mean within 0.1% of some specified or desired value, while in various other embodiments, the threshold may be, for example, 2%, 3%, 5%, and so forth, as desired or as required by the particular application.

Concurrent—refers to parallel execution or performance, where tasks, processes, or programs are performed in an at least partially overlapping manner. For example, concurrency may be implemented using “strong” or strict parallelism, where tasks are performed (at least partially) in parallel on respective computational elements, or using “weak parallelism”, where the tasks are performed in an interleaved manner, e.g., by time multiplexing of execution threads.

Station (STA)—The term “station” herein refers to any device that has the capability of communicating wirelessly, e.g. by using the 802.11 protocol. A station may be a laptop, a desktop PC, PDA, access point or Wi-Fi phone or any type of device similar to a UE. An STA may be fixed, mobile, portable or wearable. Generally in wireless networking terminology, a station (STA) broadly encompasses any device with wireless communication capabilities, and the terms station (STA), wireless client (UE) and node (BS) are therefore often used interchangeably.

Configured to—Various components may be described as “configured to” perform a task or tasks. In such contexts, “configured to” is a broad recitation generally meaning “having structure that” performs the task or tasks during operation. As such, the component can be configured to perform the task even when the component is not currently performing that task (e.g., a set of electrical conductors may be configured to electrically connect a module to another module, even when the two modules are not connected). In some contexts, “configured to” may be a broad recitation of structure generally meaning “having circuitry that” performs the task or tasks during operation. As such, the component can be configured to perform the task even when the component is not currently on. In general, the circuitry that forms the structure corresponding to “configured to” may include hardware circuits.

Transmission Scheduling—Refers to the scheduling of transmissions, such as wireless transmissions. In some implementations of cellular radio communications, signal and data transmissions may be organized according to designated time units of specific duration during which transmissions take place. As used herein, the term “slot” has the full extent of its ordinary meaning, and at least refers to a smallest (or minimum) scheduling time unit in wireless communications. For example, in 3GPP LTE, transmissions are divided into radio frames, each radio frame being of equal (time) duration (e.g. 10 ms). A radio frame in 3GPP LTE may be further divided into a specified number of (e.g. ten) subframes, each subframe being of equal time duration, with the subframes designated as the smallest (minimum) scheduling unit, or the designated time unit for a transmission. Thus, in a 3GPP LTE example, a “subframe” may be considered an example of a “slot” as defined above. Similarly, a smallest (or minimum) scheduling time unit for 5G NR (or NR, for short) transmissions is referred to as a “slot”. In different communication protocols the smallest (or minimum) scheduling time unit may also be named differently.

Resources—The term “resource” has the full extent of its ordinary meaning and may refer to frequency resources and time resources used during wireless communications. As used herein, a resource element (RE) refers to a specific amount or quantity of a resource. For example, in the context of a time resource, a resource element may be a time period of specific length. In the context of a frequency resource, a resource element may be a specific frequency bandwidth, or a specific amount of frequency bandwidth, which may be centered on a specific frequency. As one specific example, a resource element may refer to a resource unit of 1 symbol (in reference to a time resource, e.g. a time period of specific length) per 1 subcarrier (in reference to a frequency resource, e.g. a specific frequency bandwidth, which may be centered on a specific frequency). A resource element group (REG) has the full extent of its ordinary meaning and at least refers to a specified number of consecutive resource elements. In some implementations, a resource element group may not include resource elements reserved for reference signals. A control channel element (CCE) refers to a group of a specified number of consecutive REGs. A resource block (RB) refers to a specified number of resource elements made up of a specified number of subcarriers per specified number of symbols. Each RB may include a specified number of subcarriers. A resource block group (RBG) refers to a unit including multiple RBs. The number of RBs within one RBG may differ depending on the system bandwidth.

Bandwidth Part (BWP)—A carrier bandwidth part (BWP) is a contiguous set of physical resource blocks selected from a contiguous subset of the common resource blocks for a given numerology on a given carrier. For downlink, a UE may be configured with up to a specified number of carrier BWPs (e.g. four BWPs, per some specifications), with one BWP per carrier active at a given time (per some specifications). For uplink, the UE may similarly be configured with up to several (e.g. four) carrier BWPs, with one BWP per carrier active at a given time (per some specifications). If a UE is configured with a supplementary uplink, then the UE may be additionally configured with up to the specified number (e.g. four) carrier BWPs in the supplementary uplink, with one carrier BWP active at a given time (per some specifications).

Multi-cell Arrangements—A Master node is defined as a node (radio access node) that provides control plane connection to the core network in case of multi radio dual connectivity (MR-DC). A master node may be a master eNB (3GPP LTE) or a master gNB (3GPP NR), for example. A secondary node is defined as a radio access node with no control plane connection to the core network, providing additional resources to the UE in case of MR-DC. A Master Cell group (MCG) is defined as a group of serving cells associated with the Master Node, including the primary cell (PCell) and optionally one or more secondary cells (SCell). A Secondary Cell group (SCG) is defined as a group of serving cells associated with the Secondary Node, including a special cell, namely a primary cell of the SCG (PSCell), and optionally including one or more SCells. A UE may typically apply radio link monitoring to the PCell. If the UE is configured with an SCG then the UE may also apply radio link monitoring to the PSCell. Radio link monitoring is generally applied to the active BWPs and the UE is not required to monitor inactive BWPs. The PCell is used to initiate initial access, and the UE may communicate with the PCell and the SCell via Carrier Aggregation (CA). Currently Amended capability means a UE may receive and/or transmit to and/or from multiple cells. The UE initially connects to the PCell, and one or more SCells may be configured for the UE once the UE is in a connected state.

Core Network (CN)—Core network is defined as a part of a 3GPP system which is independent of the connection technology (e.g. the Radio Access Technology, RAT) of the UEs. The UEs may connect to the core network via a radio access network, RAN, which may be RAT-specific.

Downlink Control Information (DCI)—In 3GPP communications, DCI is transmitted to a mobile device or UE (e.g., by a serving base station in the network) and contains multiple different fields. Each field is used to configure one part or aspect of a scheduled communication(s) of the device. To put it another way, each field in the DCI may correspond to a specific communication parameter or parameters configuring a corresponding aspect of the scheduled communication(s) of the device. By decoding the DCI, the UE obtains all the configuring parameters or parameter values according to the fields in the DCI, thereby obtaining all the information about the scheduled communication(s) and subsequently performing the scheduled communication(s) according to those parameters/parameter values.

Various components may be described as performing a task or tasks, for convenience in the description. Such descriptions should be interpreted as including the phrase “configured to.” Reciting a component that is configured to perform one or more tasks is expressly intended not to invoke 35 U.S.C. § 112, paragraph six, interpretation for that component.

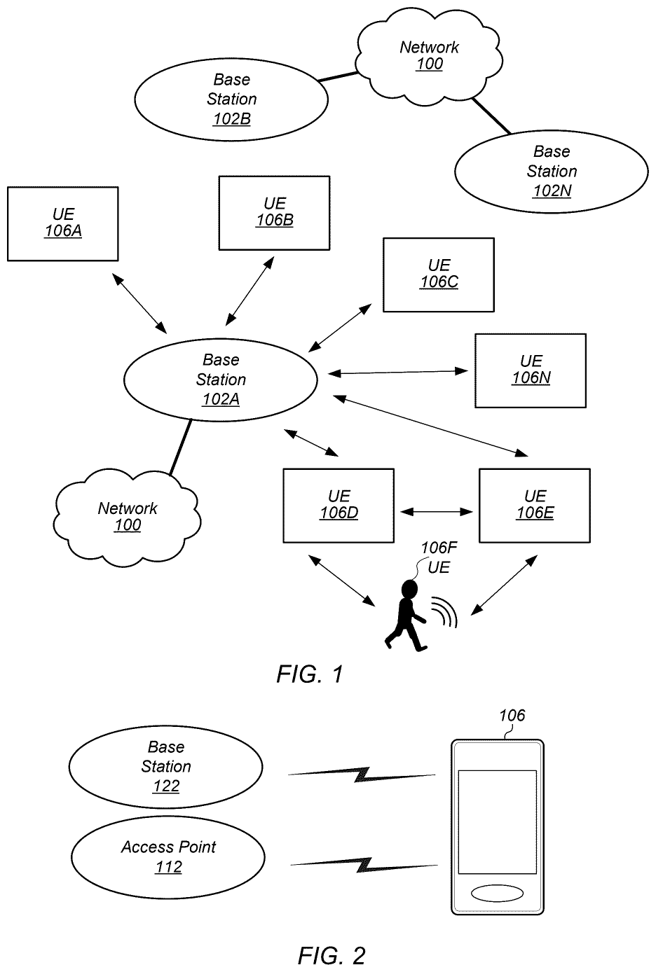

### FIGS. 1 and 2—Exemplary Communication Systems

FIG. 1 illustrates an exemplary (and simplified) wireless communication system, according to some embodiments. It is noted that the system of FIG. 1 is merely one example of a possible system, and embodiments may be implemented in any of various systems, as desired.

As shown, the exemplary wireless communication system includes base stations 102A through 102N, also collectively referred to as base station(s) 102 or base station 102. As shown in FIG. 1, base station 102A communicates over a transmission medium with one or more user devices 106A through 106N. Each of the user devices may be referred to herein as a “user equipment” (UE) or UE device. Thus, the user devices 106A through 106N are referred to as UEs or UE devices, and are also collectively referred to as UE(s) 106 or UE 106.

The base station 102A may be a base transceiver station (BTS) or cell site, and may include hardware that enables wireless communication with the UEs 106A through 106N. The base station 102A may also be equipped to communicate with a network 100 (e.g., a core network of a cellular service provider, a telecommunication network such as a public switched telephone network (PSTN), and/or the Internet, neutral host or various CBRS (Citizens Broadband Radio Service) deployments, among various possibilities). Thus, the base station 102A may facilitate communication between the user devices 106 and/or between the user devices 106 and the network 100. In particular, the cellular base station 102A may provide UEs 106 with various telecommunication capabilities, such as voice, short message service (SMS) and/or data services. The communication area (or coverage area) of the base station 106 may be referred to as a “cell.” It is noted that “cell” may also refer to a logical identity for a given wireless communication coverage area at a given frequency. In general, any independent cellular wireless coverage area may be referred to as a “cell”. In such cases a base station may be situated at particular confluences of three cells. The base station, in this uniform topology, may serve three 120 degree beam width areas referenced as cells. Also, in case of carrier aggregation, small cells, relays, etc. may each represent a cell. Thus, in carrier aggregation in particular, there may be primary cells and secondary cells which may service at least partially overlapping coverage areas but on different respective frequencies. For example, a base station may serve any number of cells, and cells served by a base station may or may not be collocated (e.g. remote radio heads). As also used herein, from the perspective of UEs, a base station may sometimes be considered as representing the network insofar as uplink and downlink communications of the UE are concerned. Thus, a UE communicating with one or more base stations in the network may also be interpreted as the UE communicating with the network, and may further also be considered at least a part of the UE communicating on the network or over the network.

The base station(s) 102 and the user devices 106 may be configured to communicate over the transmission medium using any of various radio access technologies (RATs), also referred to as wireless communication technologies, or telecommunication standards, such as GSM, UMTS (WCDMA), LTE, LTE-Advanced (LTE-A), LAA/LTE-U, 5G-NR (NR, for short), 3GPP2 CDMA 2000 (e.g., 1xRTT, 1xEV-DO, HRPD, eHRPD), Wi-Fi, WiMAX etc. Note that if the base station 102A is implemented in the context of LTE, it may alternately be referred to as an ‘eNodeB’ or ‘eNB’. Similarly, if the base station 102A is implemented in the context of 5G NR, it may alternately be referred to as ‘gNodeB’ or ‘gNB’. In some embodiments, the base station 102 (e.g. an eNB in an LTE network or a gNB in an NR network) may communicate with at least one UE having the capability to transmit reference signals according to various embodiments disclosed herein. Depending on a given application or specific considerations, for convenience some of the various different RATs may be functionally grouped according to an overall defining characteristic. For example, all cellular RATs may be collectively considered as representative of a first (form/type of) RAT, while Wi-Fi communications may be considered as representative of a second RAT. In other cases, individual cellular RATs may be considered individually as different RATs. For example, when differentiating between cellular communications and Wi-Fi communications, “first RAT” may collectively refer to all cellular RATs under consideration, while “second RAT” may refer to Wi-Fi. Similarly, when applicable, different forms of Wi-Fi communications (e.g. over 2.4 GHz vs. over 5 GHz) may be considered as corresponding to different RATs. Furthermore, cellular communications performed according to a given RAT (e.g. LTE or NR) may be differentiated from each other on the basis of the frequency spectrum in which those communications are conducted. For example, LTE or NR communications may be performed over a primary licensed spectrum as well as over a secondary spectrum such as an unlicensed spectrum and/or spectrum that was assigned to private networks. Overall, the use of various terms and expressions will always be clearly indicated with respect to and within the context of the various applications/embodiments under consideration.

As shown, the base station 102A may also be equipped to communicate with a network 100 (e.g., a core network of a cellular service provider, a telecommunication network such as a public switched telephone network (PSTN), and/or the Internet, among various possibilities). Thus, the base station 102A may facilitate communication between the user devices 106 and/or between the user devices 106 and the network 100. In particular, the cellular base station 102A may provide UEs 106 with various telecommunication capabilities, such as voice, SMS and/or data services. UE 106 may be capable of communicating using multiple wireless communication standards. For example, a UE 106 might be configured to communicate using any or all of a 3GPP cellular communication standard (such as LTE or NR) or a 3GPP2 cellular communication standard (such as a cellular communication standard in the CDMA2000 family of cellular communication standards). Base station 102A and other similar base stations (such as base stations 102B . . . 102N) operating according to the same or a different cellular communication standard may thus be provided as one or more networks of cells, which may provide continuous or nearly continuous overlapping service to UE 106 and similar devices over a wide geographic area via one or more cellular communication standards.

Thus, while base station 102A may act as a “serving cell” for UEs 106A-106N as illustrated in FIG. 1, each one of UE(s) 106 may also be capable of receiving signals from (and may possibly be within communication range of) one or more other cells (possibly provided by base stations 102B-102N and/or any other base stations), which may be referred to as “neighboring cells”. Such cells may also be capable of facilitating communication in-between user devices 106 and/or between user devices 106 and the network 100. Such cells may include “macro” cells, “micro” cells, “pico” cells, and/or cells which provide any of various other granularities of service area size. For example, base stations 102A-102B illustrated in FIG. 1 may be macro cells, while base station 102N may be a micro cell. Other configurations are also possible.

In some embodiments, base station 102A may be a next generation base station, e.g., a 5G New Radio (5G NR) base station, or “gNB”. In some embodiments, a gNB may be connected to a legacy evolved packet core (EPC) network and/or to a NR core (NRC) network. In addition, a gNB cell may include one or more transmission and reception points (TRPs). In addition, a UE capable of operating according to 5G NR may be connected to one or more TRPs within one or more gNBs.

The UE 106 might also or alternatively be configured to communicate using WLAN, BLUETOOTH™, BLUETOOTH™ Low-Energy, one or more global navigational satellite systems (GNSS, e.g., GPS or GLONASS), one and/or more mobile television broadcasting standards (e.g., ATSC-M/H or DVB-H), etc. Other combinations of wireless communication standards (including more than two wireless communication standards) are also possible. Furthermore, the UE 106 may also communicate with Network 100, through one or more base stations or through other devices, stations, or any appliances not explicitly shown but considered to be part of Network 100. UE 106 communicating with a network may therefore be interpreted as the UE(s) 106 communicating with one or more network nodes considered to be a part of the network and which may interact with the UE(s) 106 to conduct communications with the UE(s) 106 and in some cases affect at least some of the communication parameters and/or use of communication resources of the UE(s) 106.

As also illustrated in FIG. 1, at least some of the UEs, e.g. UEs 106D and 106E may represent vehicles communicating with each other and with base station 102, e.g. via cellular communications such as 3GPP LTE and/or 5G-NR communications, for example. In addition, UE 106F may represent a pedestrian who is communicating and/or interacting in a similar manner with the vehicles represented by UEs 106D and 106E. Various embodiments of vehicles communicating in a network exemplified in FIG. 1 are disclosed, for example, in the context of vehicle-to-everything (V2X) communications such as the communications specified by certain versions of the 3GPP standard, among others.

FIG. 2 illustrates an exemplary user equipment 106 (e.g., one of UEs 106A through 106N) in communication with the base station 122 and an access point 112, according to some embodiments. The UE 106 may be a device with both cellular communication capability and non-cellular communication capability (e.g., BLUETOOTH™, Wi-Fi, and so forth) such as a mobile phone, a hand-held device, a computer or a tablet, or virtually any type of wireless device. The UE 106 may include a processor that is configured to execute program instructions stored in memory. The UE 106 may perform any of the method embodiments described herein by executing such stored instructions. Alternatively, or in addition, the UE 106 may include a programmable hardware element such as an FPGA (field-programmable gate array) that is configured to perform any of the method embodiments described herein, or any portion of any of the method embodiments described herein. The UE 106 may be configured to communicate using any of multiple wireless communication protocols. For example, the UE 106 may be configured to communicate using two or more of CDMA2000, LTE, LTE-A, NR, WLAN, or GNSS. Other combinations of wireless communication standards are also possible.

The UE 106 may include one or more antennas for communicating using one or more wireless communication protocols according to one or more RAT standards, e.g. those previously mentioned above. In some embodiments, the UE 106 may share one or more parts of a receive chain and/or transmit chain between multiple wireless communication standards. The shared radio may include a single antenna, or may include multiple antennas (e.g., for MIMO) for performing wireless communications. Alternatively, the UE 106 may include separate transmit and/or receive chains (e.g., including separate antennas and other radio components) for each wireless communication protocol with which it is configured to communicate. As another alternative, the UE 106 may include one or more radios or radio circuitry which are shared between multiple wireless communication protocols, and one or more radios which are used exclusively by a single wireless communication protocol. For example, the UE 106 may include radio circuitries for communicating using either of LTE or CDMA2000 1xRTT or NR, and separate radios for communicating using each of Wi-Fi and BLUETOOTH™. Other configurations are also possible.

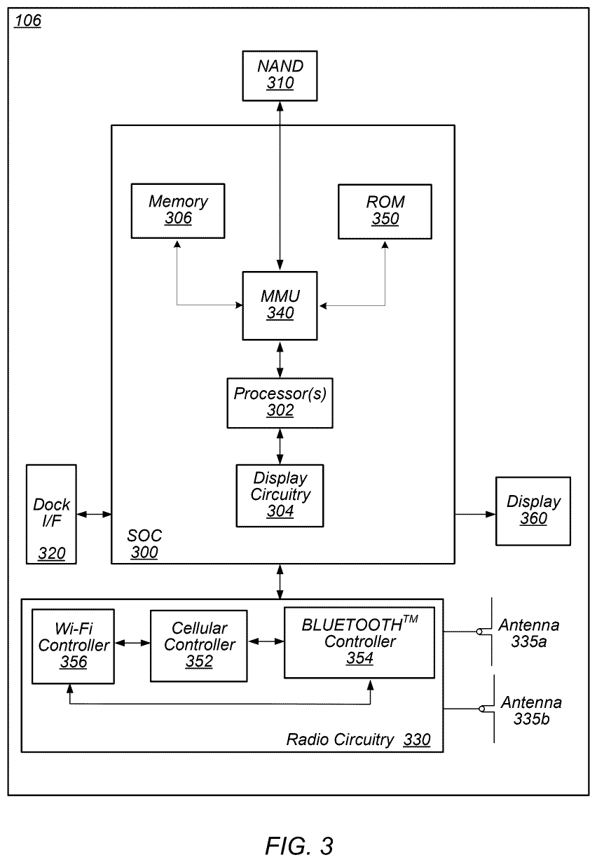

### FIG. 3—Block Diagram of an Exemplary UE

FIG. 3 illustrates a block diagram of an exemplary UE 106, according to some embodiments. As shown, the UE 106 may include a system on chip (SOC) 300, which may include various elements/components for various purposes. For example, as shown, the SOC 300 may include processor(s) 302 which may execute program instructions for the UE 106 and display circuitry 304 which may perform graphics processing and provide display signals to the display 360. The processor(s) 302 may also be coupled to memory management unit (MMU) 340, which may be configured to receive addresses from the processor(s) 302 and translate those addresses to locations in memory (e.g., memory 306, read only memory (ROM) 350, NAND flash memory 310) and/or to other circuits or devices, such as the display circuitry 304, radio circuitry 330, connector I/F 320, and/or display 360. The MMU 340 may be configured to perform memory protection and page table translation or set up. In some embodiments, the MMU 340 may be included as a portion of the processor(s) 302.

As shown, the SOC 300 may be coupled to various other circuits of the UE 106. For example, the UE 106 may include various types of memory (e.g., including NAND flash 310), a connector interface 320 (e.g., for coupling to the computer system), the display 360, and wireless communication circuitry (e.g., for LTE, LTE-A, NR, CDMA2000, BLUETOOTH™, Wi-Fi, GPS, etc.). The UE device 106 may include at least one antenna (e.g. 335a), and possibly multiple antennas (e.g. illustrated by antennas 335a and 335b), for performing wireless communication with base stations and/or other devices. Antennas 335a and 335b are shown by way of example, and UE device 106 may include fewer or more antennas. Overall, the one or more antennas are collectively referred to as antenna(s) 335. For example, the UE device 106 may use antenna(s) 335 to perform the wireless communication with the aid of radio circuitry 330. As noted above, the UE may be configured to communicate wirelessly using multiple wireless communication standards in some embodiments.

As further described herein, the UE 106 (and/or base station 102) may include hardware and software components for implementing methods for at least UE 106 to transmit reference signals according to various embodiments disclosed herein. The processor(s) 302 of the UE device 106 may be configured to implement part or all of the methods described herein, e.g., by executing program instructions stored on a memory medium (e.g., a non-transitory computer-readable memory medium). In other embodiments, processor(s) 302 may be configured as a programmable hardware element, such as an FPGA (Field Programmable Gate Array), or as an ASIC (Application Specific Integrated Circuit). Furthermore, processor(s) 302 may be coupled to and/or may interoperate with other components as shown in FIG. 3, to implement communications by UE 106 to transmit reference signals according to various embodiments disclosed herein. Specifically, processor(s) 302 may be coupled to and/or may interoperate with other components as shown in FIG. 3 to facilitate UE 106 communicating in a manner that seeks to optimize RAT selection. Processor(s) 302 may also implement various other applications and/or end-user applications running on UE 106.

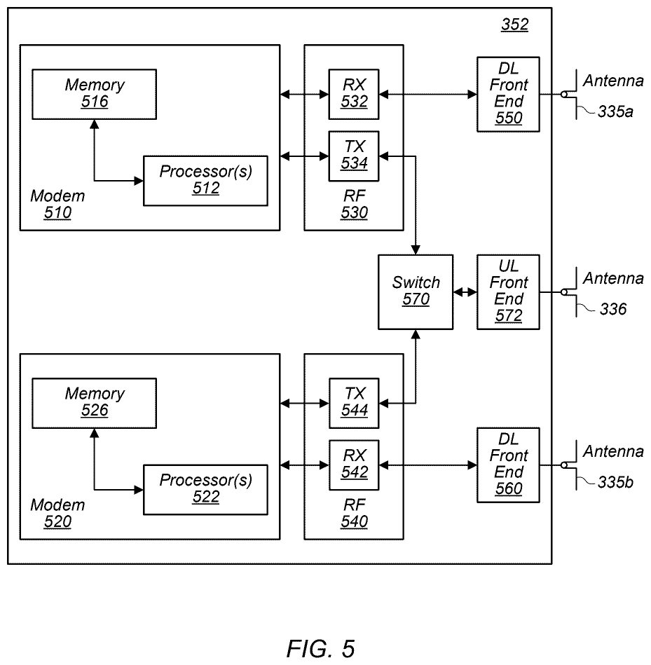

In some embodiments, radio circuitry 330 may include separate controllers dedicated to controlling communications for various respective RATs and/or RAT standards. For example, as shown in FIG. 3, radio circuitry 330 may include a Wi-Fi controller 356, a cellular controller (e.g. LTE and/or NR controller) 352, and BLUETOOTH™ controller 354, and according to at least some embodiments, one or more or all of these controllers may be implemented as respective integrated circuits (ICs or chips, for short) in communication with each other and with SOC 300 (e.g. with processor(s) 302). For example, Wi-Fi controller 356 may communicate with cellular controller 352 over a cell-ISM link or WCI interface, and/or BLUETOOTH™ controller 354 may communicate with cellular controller 352 over a cell-ISM link, etc. While three separate controllers are illustrated within radio circuitry 330, other embodiments may have fewer or more similar controllers for various different RATs and/or RAT standards that may be implemented in UE device 106. For example, at least one exemplary block diagram illustrative of some embodiments of cellular controller 352 is shown in FIG. 5 and will be further described below.

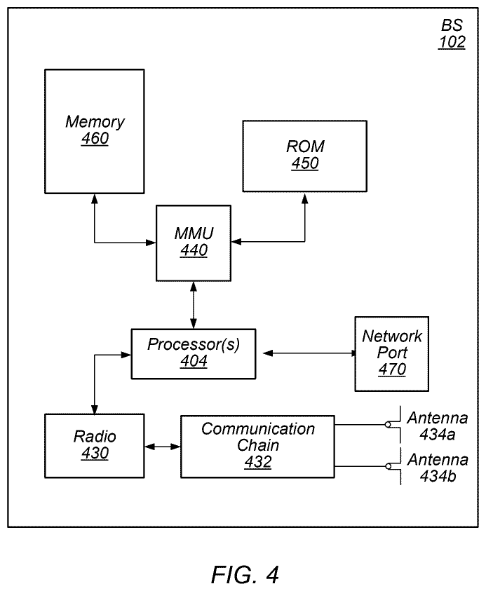

### FIG. 4—Block Diagram of an Exemplary Base Station

FIG. 4 illustrates a block diagram of an exemplary base station 102, according to some embodiments. It is noted that the base station of FIG. 4 is merely one example of a possible base station. As shown, the base station 102 may include processor(s) 404 which may execute program instructions for the base station 102. The processor(s) 404 may also be coupled to memory management unit (MMU) 440, which may be configured to receive addresses from the processor(s) 404 and translate those addresses to locations in memory (e.g., memory 460 and read only memory (ROM) 450) or to other circuits or devices.

The base station 102 may include at least one network port 470. The network port 470 may be configured to couple to a telephone network and provide a plurality of devices, such as UE devices 106, access to the telephone network as described above in FIGS. 1 and 2. The network port 470 (or an additional network port) may also or alternatively be configured to couple to a cellular network, e.g., a core network of a cellular service provider. The core network may provide mobility related services and/or other services to a plurality of devices, such as UE devices 106. In some cases, the network port 470 may couple to a telephone network via the core network, and/or the core network may provide a telephone network (e.g., among other UE devices serviced by the cellular service provider).

The base station 102 may include at least one antenna 434a, and possibly multiple antennas (e.g. illustrated by antennas 434a and 434b), for performing wireless communication with mobile devices and/or other devices. Antennas 434a and 434b are shown by way of example, and base station 102 may include fewer or more antennas. Overall, the one or more antennas, which may include antenna 434a and/or antenna 434b, are collectively referred to as antenna 434 or antenna(s) 434. Antenna(s) 434 may be configured to operate as a wireless transceiver and may be further configured to communicate with UE devices 106 via radio circuitry 430. The antenna(s) 434 communicates with the radio 430 via communication chain 432. Communication chain 432 may be a receive chain, a transmit chain or both. The radio circuitry 430 may be designed to communicate via various wireless telecommunication standards, including, but not limited to, LTE, LTE-A, 5G-NR (NR) WCDMA, CDMA 2000, etc. The processor(s) 404 of the base station 102 may be configured to implement part or all of the methods described herein, e.g., by executing program instructions stored on a memory medium (e.g., a non-transitory computer-readable memory medium). Alternatively, the processor(s) 404 may be configured as a programmable hardware element(s), such as an FPGA (Field Programmable Gate Array), or as an ASIC (Application Specific Integrated Circuit), or a combination thereof. In the case of certain RATs, for example Wi-Fi, base station 102 may be designed as an access point (AP), in which case network port 470 may be implemented to provide access to a wide area network and/or local area network(s), e.g. it may include at least one Ethernet port, and radio 430 may be designed to communicate according to the Wi-Fi standard.

### FIG. 5—Exemplary Cellular Communication Circuitry

FIG. 5 illustrates an exemplary simplified block diagram illustrative of cellular controller 352, according to some embodiments. It is noted that the block diagram of the cellular communication circuitry of FIG. 5 is only one example of a possible cellular communication circuit; other circuits, such as circuits including or coupled to sufficient antennas for different RATs to perform uplink activities using separate antennas, or circuits including or coupled to fewer antennas, e.g., that may be shared among multiple RATs, are also possible. According to some embodiments, cellular communication circuitry 352 may be included in a communication device, such as communication device 106 described above. As noted above, communication device 106 may be a user equipment (UE) device, a mobile device or mobile station, a wireless device or wireless station, a desktop computer or computing device, a mobile computing device (e.g., a laptop, notebook, or portable computing device), a tablet and/or a combination of devices, among other devices.

The cellular communication circuitry 352 may couple (e.g., communicatively; directly or indirectly) to one or more antennas, such as antennas 335a-b and 336 as shown. In some embodiments, cellular communication circuitry 352 may include dedicated receive chains (including and/or coupled to (e.g., communicatively; directly or indirectly) dedicated processors and/or radios) for multiple RATs (e.g., a first receive chain for LTE and a second receive chain for 5G NR). For example, as shown in FIG. 5, cellular communication circuitry 352 may include a first modem 510 and a second modem 520. The first modem 510 may be configured for communications according to a first RAT, e.g., such as LTE or LTE-A, and the second modem 520 may be configured for communications according to a second RAT, e.g., such as 5G NR.

As shown, the first modem 510 may include one or more processors 512 and a memory 516 in communication with processors 512. Modem 510 may be in communication with a radio frequency (RF) front end 530. RF front end 530 may include circuitry for transmitting and receiving radio signals. For example, RF front end 530 may include receive circuitry (RX) 532 and transmit circuitry (TX) 534. In some embodiments, receive circuitry 532 may be in communication with downlink (DL) front end 550, which may include circuitry for receiving radio signals via antenna 335a.

Similarly, the second modem 520 may include one or more processors 522 and a memory 526 in communication with processors 522. Modem 520 may be in communication with an RF front end 540. RF front end 540 may include circuitry for transmitting and receiving radio signals. For example, RF front end 540 may include receive circuitry 542 and transmit circuitry 544. In some embodiments, receive circuitry 542 may be in communication with DL front end 560, which may include circuitry for receiving radio signals via antenna 335b.

In some embodiments, a switch 570 may couple transmit circuitry 534 to uplink (UL) front end 572. In addition, switch 570 may couple transmit circuitry 544 to UL front end 572. UL front end 572 may include circuitry for transmitting radio signals via antenna 336. Thus, when cellular communication circuitry 352 receives instructions to transmit according to the first RAT (e.g., as supported via the first modem 510), switch 570 may be switched to a first state that allows the first modem 510 to transmit signals according to the first RAT (e.g., via a transmit chain that includes transmit circuitry 534 and UL front end 572). Similarly, when cellular communication circuitry 352 receives instructions to transmit according to the second RAT (e.g., as supported via the second modem 520), switch 570 may be switched to a second state that allows the second modem 520 to transmit signals according to the second RAT (e.g., via a transmit chain that includes transmit circuitry 544 and UL front end 572).

As described herein, the first modem 510 and/or the second modem 520 may include hardware and software components for implementing any of the various features and techniques described herein. The processors 512, 522 may be configured to implement part or all of the features described herein, e.g., by executing program instructions stored on a memory medium (e.g., a non-transitory computer-readable memory medium). Alternatively (or in addition), processors 512, 522 may be configured as a programmable hardware element, such as an FPGA (Field Programmable Gate Array), or as an ASIC (Application Specific Integrated Circuit). Alternatively (or in addition) the processors 512, 522, in conjunction with one or more of the other components 530, 532, 534, 540, 542, 544, 550, 570, 572, 335 and 336 may be configured to implement part or all of the features described herein.

In addition, as described herein, processors 512, 522 may include one or more components. Thus, processors 512, 522 may include one or more integrated circuits (ICs) that are configured to perform the functions of processors 512, 522. In addition, each integrated circuit may include circuitry (e.g., first circuitry, second circuitry, etc.) configured to perform the functions of processors 512, 522.

In some embodiments, the cellular communication circuitry 352 may include only one transmit/receive chain. For example, the cellular communication circuitry 352 may not include the modem 520, the RF front end 540, the DL front end 560, and/or the antenna 335b. As another example, the cellular communication circuitry 352 may not include the modem 510, the RF front end 530, the DL front end 550, and/or the antenna 335a. In some embodiments, the cellular communication circuitry 352 may also not include the switch 570, and the RF front end 530 or the RF front end 540 may be in communication, e.g., directly, with the UL front end 572.

### Device-to-Device Communications

Device-to-device (D2D) communication refers to mobile devices, e.g., user equipment devices (UEs) directly communicating with each other without transferring data through a base station (BS) or other higher-level network infrastructure. D2D communication plays a crucial role in enhancing the coverage and transmission capacity of cellular and D2D communications. One example of D2D communications was provided above with respect to FIG. 1, in which UEs 106D and 106E may represent vehicles communicating directly with each other. Various embodiments of vehicles communicating with each other as exemplified in FIG. 1 may be in the context of vehicle-to-everything (V2X) communications which cover D2D communications, such as the communications specified by certain versions of the 3GPP standard. D2D-enabled cellular networks may make provisions for D2D users to share spectrum resources in two different ways. In-band D2D communications may take place over the licensed spectrum while out-band D2D communication may take place over the unlicensed spectrum. In-band D2D may be further divided into two categories, an underlay category in which D2D users share the same frequency resources used by cellular users, and an overlay category in which both network-bases and D2D communications use orthogonal spectrum resources.

With the rising number of cellular users, it has become challenging to accommodate all users within the limited available spectrum and to provision wide bandwidths for high data rate applications such as online gaming, video sharing etc. One way of improving the energy efficiency of wireless networks includes the use of relay nodes or relay UEs. Instead of one long hop from one node to another, various UEs may be operated as strategically deployed/positioned relays to turn a single long hop into two or more shorter hops. Although the operation of relays is greatly affected by pathloss models and environmental conditions, it has proven effective in reducing pathloss and improving D2D communications.

### Sidelink Communications and End-to-End Signaling via Relays

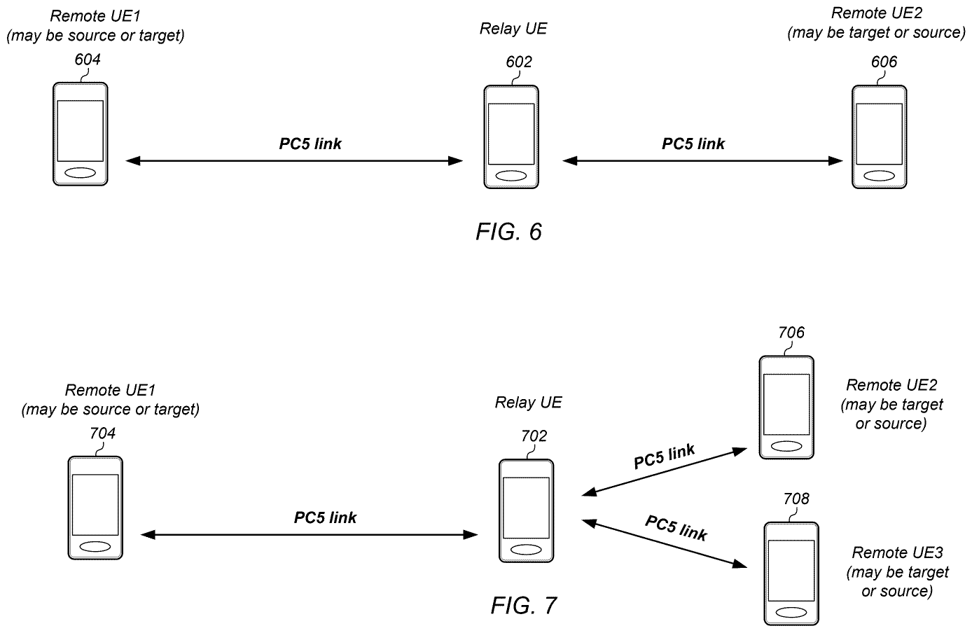

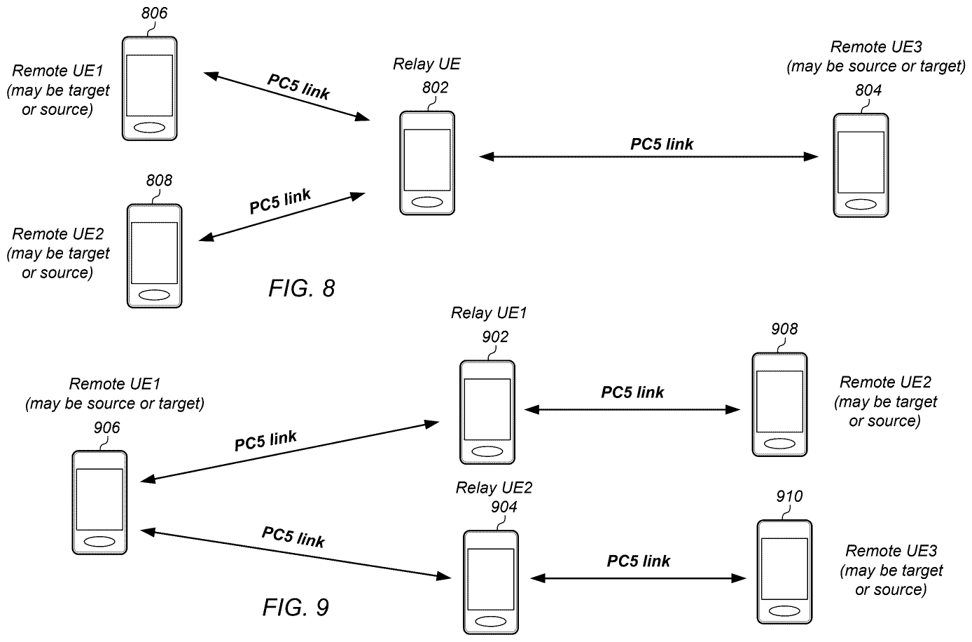

In D2D communications, e.g., cellular wireless communications, sidelink communication (also referred to as communication over a PC5 link, where PC5 link refers to sidelink) represents the communication mechanism between devices that is not carried through a base station, e.g., it is not carried through eNB/gNB. In other words, the devices communicate with each other without the communication requiring facilitation by a base station. It is in this sense that the devices may be said to be communicating with each other directly. As previously mentioned, sidelink communications may be improved through select UEs operating a relays or relay devices. Specifications are currently being drawn up for a single hop UE-to-UE (U2U) relay, i.e., for the establishment of sidelink (or PC5) communications between a remote UE and a relay UE. A variety of different U2U Relay scenarios with a more flexible topology than the UE-to-network (UE-to-NW, also known as U2N) relay case are under consideration. 3GPP NR communications are established over multiple layers. Layer 1 is the physical layer, Layer 2 includes the media access control (MAC), radio link control (RLC) and packet data convergence protocol (PDCP), and Layer 3 is the radio resource control (RRC) layer, as also configured in the communication protocol stack. Layer 2 of the UE-to-UE relay is used to encapsulate end-to-end PC5 (or sidelink, SL) traffic in a security payload that hides the data contents from the relay UE. A Sidelink Relay Adaption Layer (SRAP) is needed to distinguish multiplexed end-to-end traffic during sidelink (SL) communications. FIGS. 6 to 9 show examples of different possible communication scenarios between remote UEs via relay(s) or relay UE(s).

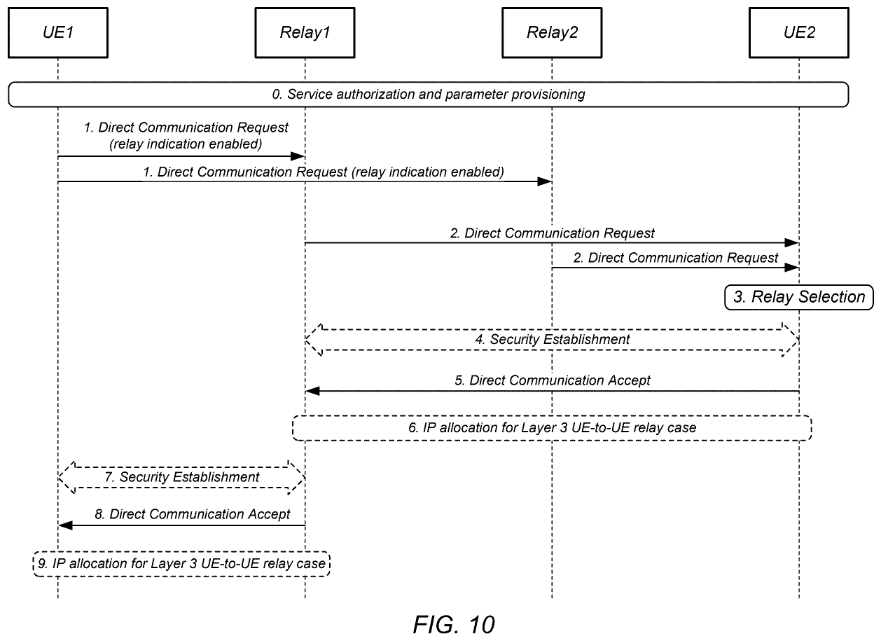

FIG. 10 shows an exemplary timing diagram of a Layer 3 UE-to-UE (U2U) setup procedure between remote UEs and relay UEs. As shown in FIG. 10, UE1 requests direct communication with Relay1 and Relay2 (step 1), and Relay1 and Relay2 both request direct communication with UE2 (step 2). According to the relay selection (step 3), Relay1 is selected, and direct communication is established between Relay1 and UE2 (steps 4, 5, 6), and between UE1 and Relay1 (steps 7, 8, 9).

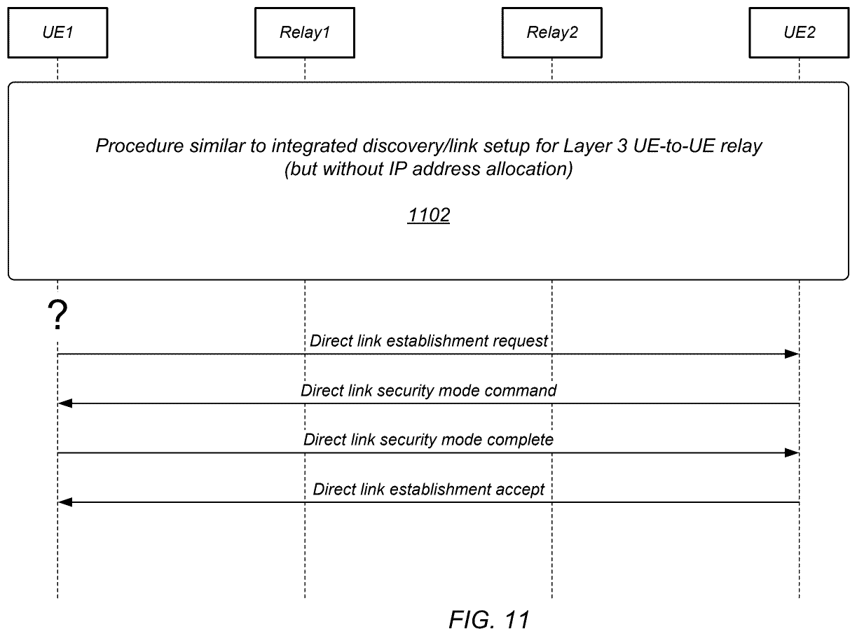

FIG. 11 shows an exemplary timing diagram of a possible Layer 2 UE-to-UE (U2U) setup procedure. The first part of the procedure includes procedure 1102, which may be similar to the integrated discovery/link setup illustrated for Layer 3 in FIG. 10, but without the IP address allocation (i.e., without steps 6 and 9). The Layer 2 U2U setup also requires additional steps for end-to-end PC5 link setup between UE1 and UE2, which, in this case, would need to take place via Relay1, as UE1 and UE2 are not in direct communication with each other. The additional steps are indicated by the arrows, collectively representing a 4-step additional procedure. There is a need to determine the proper signaling steps for the 4-step additional procedure to achieve the desired Layer 2 end-to-end PC5 link between UE1 and UE2 via a relay(s), in this case via Relay1.

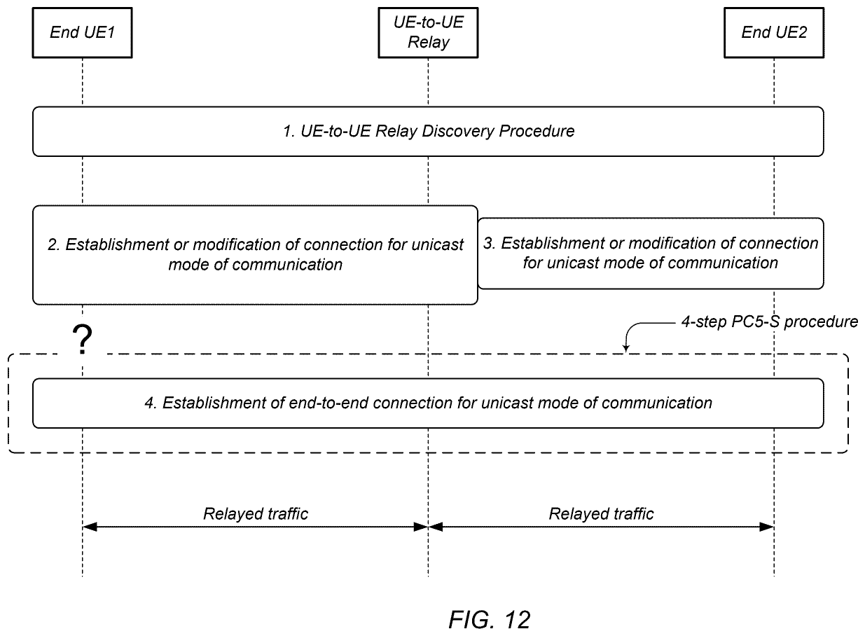

Proximity Services (ProSe), first introduced in Release 12 of the 3GPP specifications, is a D2D (Device-to-Device) technology that allows UEs to detect each other and to communicate directly. FIG. 12 shows an exemplary communication diagram for 5G ProSe Communication via 5G ProSe Layer-2 UE-to-UE Relay. The communication diagram exemplifies a possible Layer 2 UE-to-UE (U2U) setup procedure which includes a distinct end-to-end connection establishment for unicast mode of communication (step 4), which may be implemented based on the additional 4-step procedure illustrated in FIG. 11.

### End-to-End PC5 Link for Layer 2 of UE-to-UE Relay

The PC5 signaling protocol stack (PC5-S) is used for control plane signaling over the PC5 interface to establish, maintain, and release a secure direct link between two UEs. When the communication is established between the pair of UEs via a relay UE, the information securely passed via control plane signaling between the pair of UEs should not be visible or accessible to the relay UE. A PC5 link used for direct communications between a pair of UEs is usually identified by (or is defined by) a pair of L2 addresses (or IDs). The PC5-S protocol establishes a secure PC5 link between a pair of UEs, e.g., via L2 addresses. The L2 addresses (or L2 IDs) used in 3GPP LTE and 3GPP NR communications are specified to be 24-bit long. However, an L2 address is not always enclosed in the PC5-S message itself, as this 24-bit address is included in lower layer headers (L2+L1 headers) and then stored by the peer UE to identify this link. The 3GPP R 16/R17 PC5-S message for “Direct Link Establishment Request” does not contain an “L2 address”, it only contains source user information (Source User Info) and target user information (Target User Info.) Per current 3GPP UE-to-UE relay specification considerations, the following information is to be included in the Direct link establishment request:
Source end-UE information,
U2U relay information,
Target end-UE information, and
Optionally, target L2 address (L2 ID).

The optional target L2 address may assist the target remote UE during the discovery process, but the target UE may not necessarily use or continue to use this L2 ID for the end-to-end Layer 2 link.

This gives rise to an issue whereby a “conceptual” end-to-end PC5 link (an end-to-end PC5-RRC connection) may exist, but it remains unclear what the L2 IDs associated with this end-to-end PC5 link would be. At least three different options may be considered to address this issue:
Option 1: No conventional L2 IDs (or addresses) are used in identifying the end-to-end link, at least for the case of transporting end-to-end traffic. One of the reasons for this option is that no L2 IDs (or addresses) are ever associated with this end-to-end link, since it is considered a virtual PC5 link without a need to use L2 addresses over-the-air (OTA). Another reason for this option is the possibility of replacing the L2 addresses (when identifying the end-to-end L2 PC5 link) with a local ID (or address), which may be much shorter than the otherwise specified 24-bit L2 address, thereby significantly reducing the header overhead associated with each end-to-end PDU to be transported between two remote UEs.
Option 2: The L2 IDs used may be the same L2 ID(s) as those used by the remote UEs for their per-hop PC5 link between the remote UE and the relay UE, and
Option 3: New L2 IDs specifically established to identify the end-to-end L2 PC5 link between the remote UEs is used. The L2 IDs may be new L2 IDs for “non-relay” PC5 communications, with the new L2 IDs differing from the L2 ID used by the remote UE to communicate with the relay UE and not to be used OTA. For example, the new L2 addresses identifying the end-to-end L2 PC5 link may be generated and/or exchanged during the upper layer end-to-end link establishment procedure (PC5-S procedure).

Regardless of which option is used, each option raises additional associated issues. For example, access stratum (AS) layer procedures (and upper-layer procedures) may need to be correspondingly designed in support of each respective option.

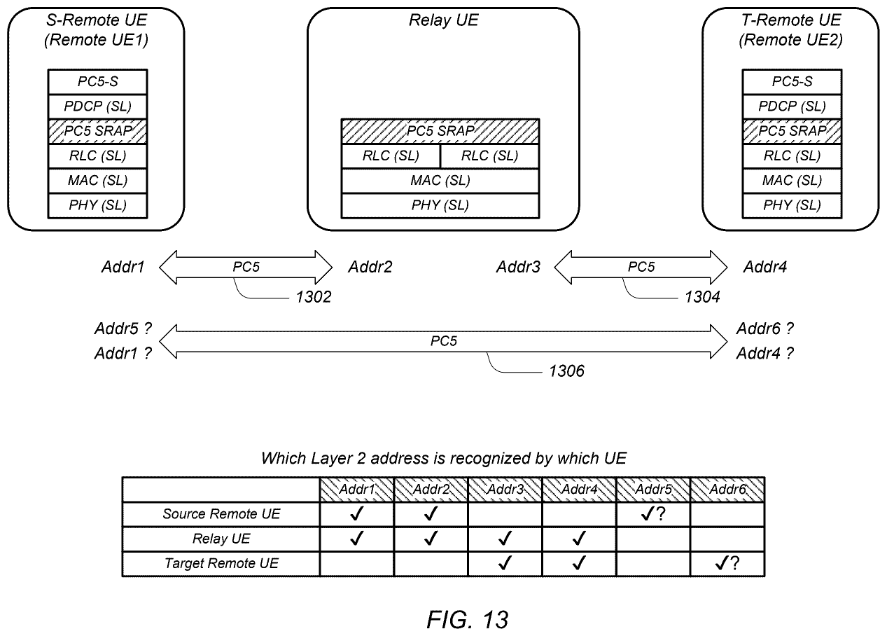

Every end-to-end (e2e) PC5-S message from a source remote-UE to a target remote-UE uses a sidelink relay adaptation layer (SRAP) header. The SRAP header includes UE IDs (e.g., L2 ID) to identify the end-to-end link. This is illustrated in FIG. 13, which shows an exemplary system diagram of device communication layers (e.g., communication protocol stack layers) for remote UEs and a relay UE. FIG. 13 illustrates the issue with SRAP for Layer 2 UE-to-UE (U2U) end-to-end PC5 signaling that involves a relay UE(s). Specifically, the issue is how to identify the PC5 link 1306 between the source remote (S-Remote) UE and target remote (T-Remote) UE when communications between remote UE1 and remote UE2take place via the relay UE.

As illustrated in FIG. 13, the L2 ID of remote UE1 for the PC5 link 1302 between remote UE1 and the relay UE is Addr1, while the L2 ID of the relay UE is Addr2. Similarly, the L2 ID of remote UE2 for the PC5 link 1304 between remote UE2 and the relay UE is Addr4, while the L2 ID of the relay UE is Addr3. The remaining issue is what respective L2 IDs or addresses are to be used for remote UE1 and remote UE2, respectively, for the end-to-end PC5 connection or link 1306 to be established between remote UE1 and remote UE2 via the relay UE. In reference to the three options indicated above, according to option 1, no L2 address is to be used. According to option 2, Addr1 and Addr2 may represent the respective L2 IDs for remote UE1 and remote UE2. According to option 3, new L2 IDs Addr5 and Addr6 may represent the respective L2 IDs for remote UE1 and remote UE2. The table in FIG. 13 illustrates which of those L2 IDs or addresses is recognized by which UE. Remote UE1 recognizes Addr1 and Addr2, remote UE2 recognizes Addr3 and Addr4, and relay UE recognizes Addr1, Addr2, Addr2, and Addr4. In case of option 2, the issue is how would remote UE1 recognize Addr4 and how would remote UE2 recognize Addr1. In case of option 3, the issue is how would remote UE1 recognize Addr6 and how would remote UE2 recognize Addr5.

### Option 1—No Conventional L2 IDs Are Used for Identifying the End-to-End L2 PC5 Link

In place of using conventional 24-bit L2 IDs (or addresses) to identify the end-to-end L2 PC5 link, a new type of “ID”, e.g., a “local ID”, or a new pair of ID(s), or pair of local IDs may be used in the SRAP header for the UE-to-UE relay. In some embodiments, a single local ID may represent the end-to-end link via the relay UE (uniquely identified by the L2 U2U relay UE). In some embodiments, two local IDs may represent two corresponding PC5 hops (or two remote UEs), e.g., a hop between the relay UE and a first remote UE and a hop between the relay UE and s second remote UE. The two local IDs may be used in combination to represent the end-to-end PC5 link (or sidelink communication link) between the remote UEs via the relay UE. Accordingly, different solutions for a corresponding local ID generation and exchange method with a PC5-RRC procedure may be established:
Solution 1: Relay UE may determine or allocate a single local ID and disseminate the local ID to the remote UEs for use by the remote UEs, Solution 2-1: Relay UE may assign or allocate two respective local IDs to represent the two respective remote UE(s) or the corresponding PC5 hops between the relay UE and the remote UEs, and may respectively share the local IDs with the remote UE(s), and
Solution 2-2: One of the remote UEs, for example the source remote-UE may determine or allocate a first “local ID” for the first PC5 hop between the source remote-UE and the relay UE, and the relay UE may determine a second local ID for the second PC5 hop between the relay UE and the target remote-UE.

### Option 2—Per-Hop UE Source L2 IDs Are Used

Since each remote UE only recognizes its own source-L2-ID, a procedure may be established for determining the other L2 ID:
Solution 3: A PC5-RRC procedure may be used by the relay UE to share with each peer remote UE the other peer remote UE's L2 address,
Solution 4: No PC5-RRC procedure used for the relay to share the L2 IDs. The SRAP header may contain an empty target UE ID field that may be filled by the relay UE with the appropriate corresponding L2 ID when the relay UE is forwarding communication(s) to the remote UEs,
Solution 5: No PC5-RRC procedure is used for the relay to share the L2 IDs. PC5-S procedures may be used to enable the relay UE to share the L2 address or L2 ID of a peer remote UE with the other peer remote UE.

### Option 3—New L2 IDs, Different From Per-hop UE Source L2 IDs, Are Used

New L2 IDs may be defined by upper layers for an end-to-end PC5 link between remote UEs via a relay UE, and the new L2 IDs may be exchanged among the source remote-UE, relay UE, and target remote-UE before the initiation of the L2 end-to-end PC5 link setup between the source remote-UE and the target remote-UE:
Solution 6: An enhanced PC5-S procedure may be devised to include the exchange of the end-to-end L2 IDs defined by the upper layers (e.g., hop by hop).

### Configuring PC5 Relay RLC Channel Support for End-to-End PC5-S Procedures Used in Setting Up the End-to-End Links, e.g., End-to-End SL SRBs

Solution 7-1: A single fixed/default configuration for at least SL-SRB 0/1/2 with a fixed/default logical channel IDs (LCIDs) may be used in both PC5 hops (between source UE and relay, and between relay and target UE). The relay UE may simply map the SRAP traffic from a PC5 hop to the next PC5 hop from one fixed SL RLC channel to another fixed SL RLC channel,
Solution 7-2: The relay UE may use PC5-RRC signaling to configure the PC5 Relay RLC Channel(s) to support end-to-end SL SRBs in both PC5 hops, and
Solution 7-3: The source remote-UE may use PC5-RRC to configure the PC5 Relay RLC channel used in the first hop, and the relay UE may initiate a PC5-RRC procedure to configure the PC5 relay RLC channel used in second hop.

From signaling design perspective, a given variant of Solution 7 may work for certain solutions for option 1, option 2, and/or option 3, as indicated below by way of select examples:
Solution 7-1 in combination with Solution 4,
Solution 7-2 in combination with Solution 3,
Solution 7-2 in combination with Solution 1,
Solution 7-2 in combination with Solution 2-1,

If the relay UE needs to initiate the RRC procedure, it may take care of both the PC5 RLC channel configuration and the UE L2 ID configuration,
Solution 7-3 in combination with Solution 2-2,

For the S-Remote UE and the relay UE to respectively initiate PC5-RRC configuration.

Additional combinations are also contemplated:
Solution 7-1 may be combined with any of Solutions 1-6, and
Upper layer PC5-S solutions 5 and 6 may be combined with any variant of Solution 7.

### Timing of PC5-RRC (Access Stratum Layer) Procedures

For any solution that uses a PC5-RRC procedure, the PC5-RRC procedure may need to take place prior to initiation of any end-to-end PC5-S procedures. The timing may take advantage of the “pending” status that an “end-to-end configuration is absent” for an established PC5 link between a remote UE and a Relay UE, which is to be used uniquely for an association of source UE (S-remote UE) information, relay UE information, and target UE (T-remote UE) information U2U relay context in the upper layer. End-to-end SL UE-to-UE traffic may be thereby correctly anchored with lower layer PC5 Relay RLC channels in the correct PC5 hop. The procedure may be used to set up a single end-to-end PC5 link between two remote UEs via a relay UE, based on an already established per-hop PC5 link between a remote UE and the relay UE, e.g., based on an already established PC5 link between a source remote-UE and the relay UE. For multiple simultaneous instances or occurrences of this procedure, the UE receiving the PC5-RRC message may not recognize which end-to-end PC5 link the procedure is intended to establish.

### First Exemplary Procedure for Establishing Layer 2 End-to-End PC5 Link via Relay

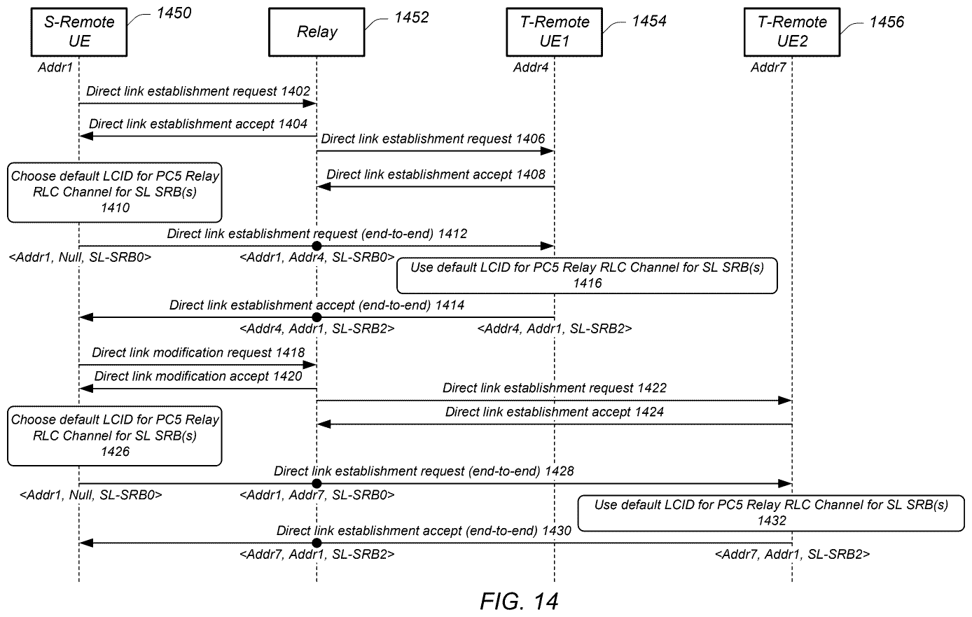

FIG. 14 shows a first exemplary timing diagram illustrating signaling flow details for establishing a direct end-to-end Layer 2PC5 link between two remote UEs via a relay UE, according to some embodiments. The timing diagram illustrates an exemplary combination of Solution 4 and Solution 7-1. It should be noted that while the timing diagram of FIG. 14 illustrates the use of two conventional L2 addresses (according to Solution 4), in alternative embodiments, the signaling mechanism illustrated in FIG. 14 may be also be used by remote UEs 1450, 1454, and 1456, and relay UE 1452 to establish the direct end-to-end L2 PC5 link identified by two local IDs, or a single local ID (as set out for Option 1.) For example, after relay UE 1452 allocates the local ID(s), it may not share the allocated local ID(s) with the remote UEs 1450, 1454 and 1456 via PC5-RRC signaling. Instead, relay UE 1452 may fill the SRAP header with the local ID(s) after receiving the first SL-SRB0 message from the source remote UE 1450 with a Null target ID in the SRAP header. It is also worth noting that the use of all zero (Null) to indicate that the source remote UE is unsure about the target end-to-end address to be used when triggering the very first SL-SRB message is also exemplary, and a specific non-zero ID value may also be reserved and used for the same purpose.

A direct PC5 link may be established between remote UE 1450 and relay UE 1452 (via 1402, 1404), between relay UE 1452 and remote UE 1454 (via 1406, 1408), and between relay UE 1454 and remote UE 1456 (via 1422 and 1424). A default LCID may be chosen for the PC5 relay RLC channel for the SL SRB(s) (1410). Once the PC5 link between remote UE 1450 and relay UE 1452 is established (or modified), the source remote UE 1450 may send an end-to-end direct link establishment request 1412 with the SRAP header carrying the following parameter values:
Source L2 ID=Addr1;
Target L2 ID=All-zeros (Null),
Bearer ID=SL-SRB0.

When the relay UE 1452 receives this SRAP PDU indicating SL-SRB0 with an empty UE ID/Link ID field (when a single local ID is used in the SRAP header) or Null target UE ID (when two local IDs are used in the SRAP header), the relay UE 1452 may identify/determine that there is one pending end-to-end link that needs to be set up between Addr 1 (or remote UE 1450) and Addr 4 (or remote UE 1454), and it may insert the Addr 4 of the target remote-UE (or appropriate local ID when using local ID(s)) into the SRAP header for the second PC5 hop from relay UE 1452 to remote UE 1454. After the target remote UE 1454 receives the forwarded message showing this is a SL-SRB0 message, it will also identify/determine that the two addresses/IDs enclosed in the SRAP header are to be used for the one pending end-to-end link which has not yet been associated with L2 addresses. The default LCID may be used for the PC5 relay RLC channel (1416). The direct end-to-end PC5 link between remote UE 1450 and remote UE 1454 using Addr1 and Addr4, respectively, may thus be established, as confirmed via accept message 1414.

When multiplexing a second end-to-end remote-UE-to-remote-UE link in the same PC5 hop (in this case the hop between remote UE 1450 and relay UE 1452), the SL-SRB0 message may appear the same way and the relay UE may also recognize which “remote UE address” to insert into the SRAP header (e.g., Addr7 of T-Remote UE 2). Accordingly, a default LCID may again be chosen for the PC5 relay RLC channel for the SL SRB(s) (14126), and the source remote UE 1450 may send an end-to-end direct link establishment request 1428 with the SRAP header carrying the same values as for request 1412. When the relay UE 1452 receives this SRAP PDU indicating SL-SRB0 with empty UE ID field (or Null target UE ID), the relay UE 1452 may identify/determine that there is one pending end-to-end link that needs to be set up between Addr 1 and Addr 7, and it may insert the Addr 7 of the target remote-UE into the SRAP header for the second PC5 hop between relay UE 1452 and remote UE 1456. After the target remote UE 1456 receives the forwarded message showing this is a SL-SRB0 message, it will also identify/determine that the two addresses/IDs enclosed in the SRAP header are to be used for the one pending end-to-end link which has not yet been associated with L2 addresses. The default LCID may be used for the PC5 relay RLC channel (1432). The direct end-to-end PC5 link between remote UE 1450 and remote UE 1456 using Addr1 and Addr7, respectively, may thus be established, as confirmed via accept message 1430.

### Second Exemplary Procedure for Establishing Layer 2 End-to-End PC5 Link via Relay

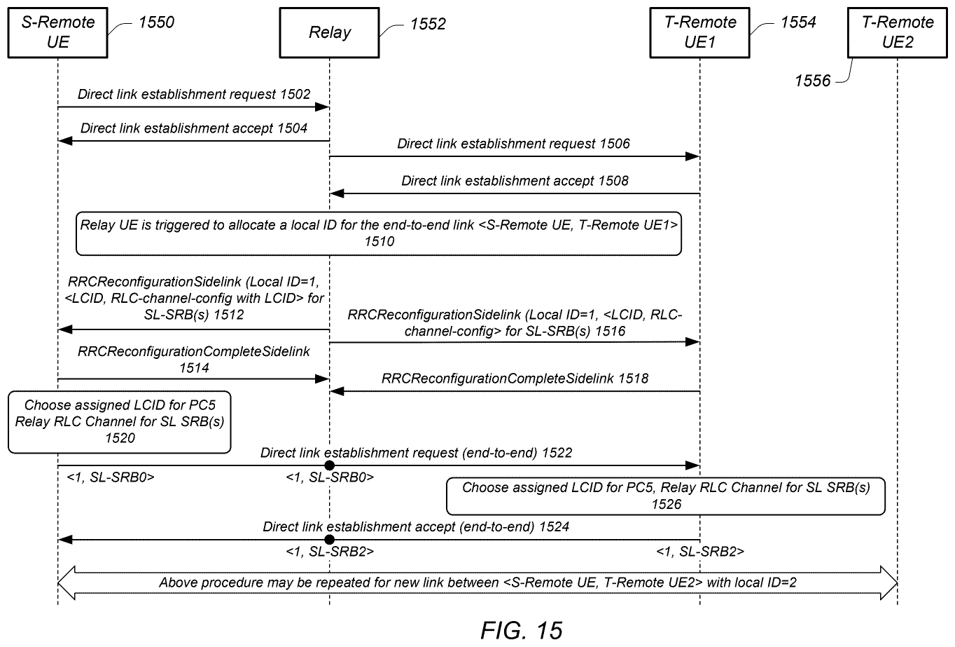

FIG. 15 shows a second exemplary timing diagram illustrating signaling flow details for establishing a direct end-to-end Layer 2 PC5 link between two remote UEs via a relay UE, according to some embodiments. The timing diagram illustrates one exemplary combination of Solution 1 and Solution 7-2.

A direct PC5 link may be established between remote UE 1550 and relay UE 1552 (via 1502, 1504), and between relay UE 1552 and remote UE 1554 (via 1506, 1508). The relay UE 1552 may be triggered to allocate a local ID for the end-to-end link between remote UE 1550 and remote UE 1554 (1510). The relay UE 1552 may accordingly initiate a PC5-RRC message (“RRCReconfigurationSidelink”) to respectively reconfigure the sidelink (or PC5 link) between relay 1552 and remote UE 1550 (1512) and between relay 1552 and remote UE 1554 (1516), to assign a local ID to represent the end-to-end link between remote UE 1550 and remote UE 1554, and/or to represent the PC5 Relay RLC Channels for the end-to-end SL-SRB(s) between remote UE 1550 and remote UE 1554. Once the respective sidelink reconfigurations have completed (messages 1514, 1518), the assigned LCID for PC5 relay RLC channel for SL SRB(s) may be chosen (1520) and the direct link establishment request for the end-to-end PC5 link between remote UE 1550 and remote UE 1554 may be transmitted by remote UE 1550, with the SRAP header carrying the local ID representative of the end-to-end link (1522). The assigned LCID for PC5 relay RLC channel for SL SRB(s) may be chosen (1526), and the direct end-to-end PC5 link between remote UE 1550 and remote UE 1554 using local ID ‘1’ may be thus established, as confirmed via accept message 1524. The procedure may be repeated for an end-to-end PC5 link (or sidelink) between remote UE 1550 and remote UE 1556, with a different local ID, e.g., local ID ‘2’.

A single ID may comprise N bits to represent 2^{N} different possible links between a source remote-UE and a target remote-UE via the same relay UE. The local ID may represent a bidirectional link, or two local IDs may be used for two corresponding unidirectional links, each local ID corresponding to a different respective remote UE.

### Third Exemplary Procedure for Establishing Layer 2 End-to-end PC5 Link via Relay

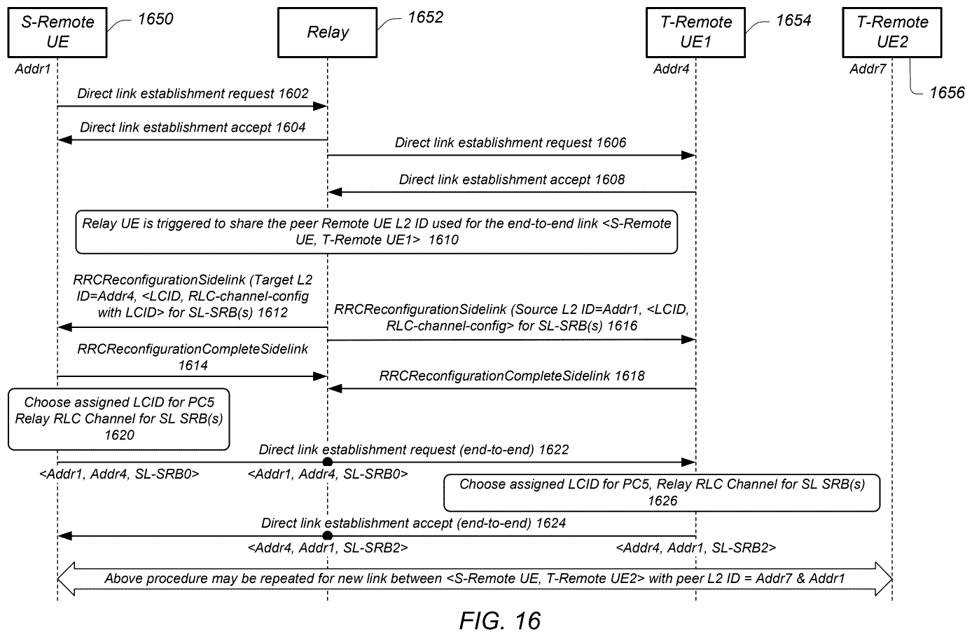

FIG. 16 shows a third exemplary timing diagram illustrating signaling flow details for establishing a direct end-to-end Layer 2PC5 link between two remote UEs via a relay UE, according to some embodiments. The timing diagram illustrates one exemplary combination of Solution 3 and Solution 7-2.

A direct PC5 link may be established between remote UE 1650 and relay UE 1652 (via 1602, 1604), and between relay UE 1652 and remote UE 1654 (via 1606, 1608). The relay UE 1652 may be triggered to share the peer remote UE L2 ID used for the end-to-end link between remote UE 1650 and remote UE 1564 (1610). The relay UE 1652 may accordingly initiate a PC5-RRC message (“RRCReconfigurationSidelink”) to reconfigure the sidelink (or PC5 link) between relay 1652 and remote UE 1650 to share the Layer 2 address of remote UE 1654 (Addr4) and/or the PC5 Relay RLC Channels for the end-to-end SL-SRB(s) with remote UE 1650 (1612). The relay UE 1652 may similarly initiate a PC5-RRC message (“RRCReconfigurationSidelink”) to reconfigure the sidelink (or PC5 link) between relay 1652 and remote UE 1654 to share the Layer 2 address of remote UE 1650 (Addr1) and/or the PC5 Relay RLC Channels for the end-to-end SL-SRB(s) with remote UE 1654 (1616). Once the respective sidelink reconfigurations have completed (messages 1614, 1618), the assigned LCID for PC5 relay RLC channel for SL SRB(s) may be chosen (1620) and the direct link establishment request for the end-to-end PC5 link between remote UE 1650 and remote UE 1654 may be transmitted by remote UE 1650, with the SRAP header carrying the respective addresses Addr1 and Addr4 representative of the end-to-end link (1622). The assigned LCID for PC5 relay RLC channel for SL SRB(s) may be chosen (1626), and the direct end-to-end PC5 link between remote UE 1650 and remote UE 1654 using Addr1 and Addr4 may be thus established, as confirmed via accept message 1624. The procedure may be repeated for an end-to-end PC5 link (or sidelink) between remote UE 1650 and remote UE 1656, using peer Layer 2 IDs or addresses Addr1 and Addr7, respectively.

### Fourth Exemplary Procedure for Establishing Layer 2 End-to-end PC5 Link via Relay

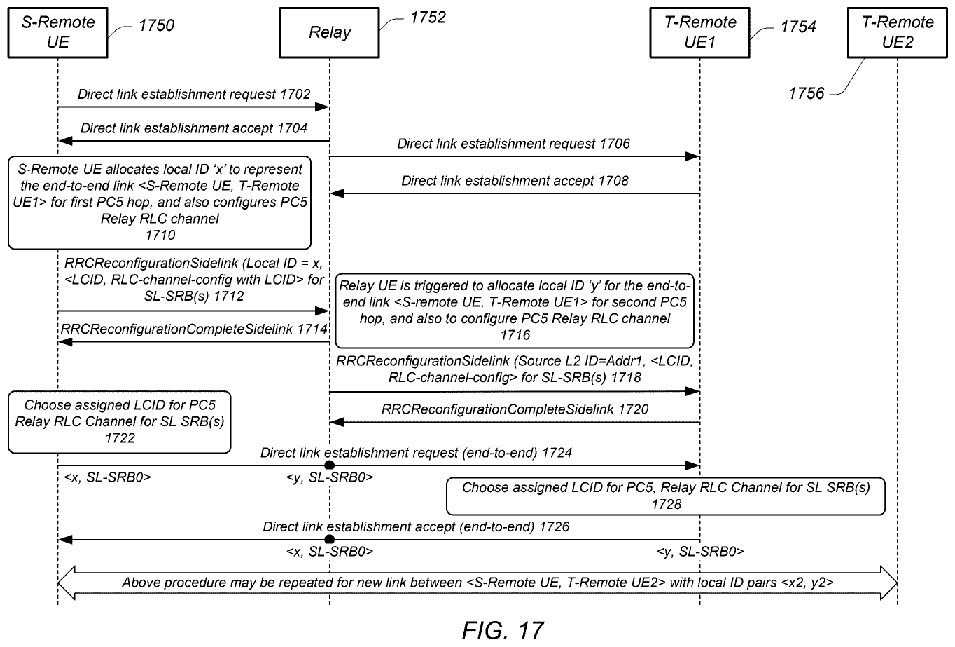

FIG. 17 shows a fourth exemplary timing diagram illustrating signaling flow details for establishing a direct end-to-end Layer 2 PC5 link between two remote UEs via a relay UE, according to some embodiments. The timing diagram illustrates one exemplary combination of Solution 2-2 and Solution 7-3.

A direct PC5 link may be established between remote UE 1750 and relay UE 1752 (via 1702, 1704), and between relay UE 1752 and remote UE 1754 (via 1706, 1708). Remote UE 1750 may allocate a local ID ‘x’ to represent the end-to-end PC5 link between remote UE 1750 and remote UE 1754 for the first PC5 hop, and may also configure the PC5 Relay RLC channel (1710). Relay UE 1752 may be triggered to allocate a local ID ‘y’ to represent the end-to-end PC5 link between remote UE 1750 and remote UE 1754 for the second PC5 hop, and also to configure the PC5 Relay RLC channel (1716). The remote UE 1750 may initiate a PC5-RRC message (“RRCReconfigurationSidelink”) to accordingly reconfigure the sidelink (or PC5link) between relay remote UE 1750 and relay UE 1752 (1712), and relay UE 1752 may similarly initiate a PC5-RRC message (“RRCReconfigurationSidelink”) to accordingly reconfigure the sidelink (or PC5 link) between relay 1752 and remote UE 1754 (1718). Once the respective sidelink reconfigurations have completed (messages 1714, 1720), the assigned LCID for PC5 relay RLC channel for SL SRB(s) may be chosen (1722) and the direct link establishment request for the end-to-end PC5 link between remote UE 1750 and remote UE 1754 may be transmitted by remote UE 1750, with the SRAP header carrying Layer 2 ID ‘x’, representative of the end-to-end link for the first hop (1724). The assigned LCID for PC5 relay RLC channel for SL SRB(s) may be chosen (1728), and the direct end-to-end PC5 link between remote UE 1750 and remote UE 1754 using local IDs ‘x’ and ‘y’ may be thus established, as confirmed via accept message 1726. The procedure may be repeated for an end-to-end PC5 link (or sidelink) between remote UE 1750 and remote UE 1756, using a different pair of L2 local IDs, e.g., “x2, y2.”

Each N-bit Local ID may represent 2^{N} different end-to-end PC5 links from the perspective of the source remote-UE. Two Local IDs may be consecutively used in the SRAP header.

### Fifth Exemplary Procedure for Establishing Layer 2 End-to-end PC5 Link via Relay

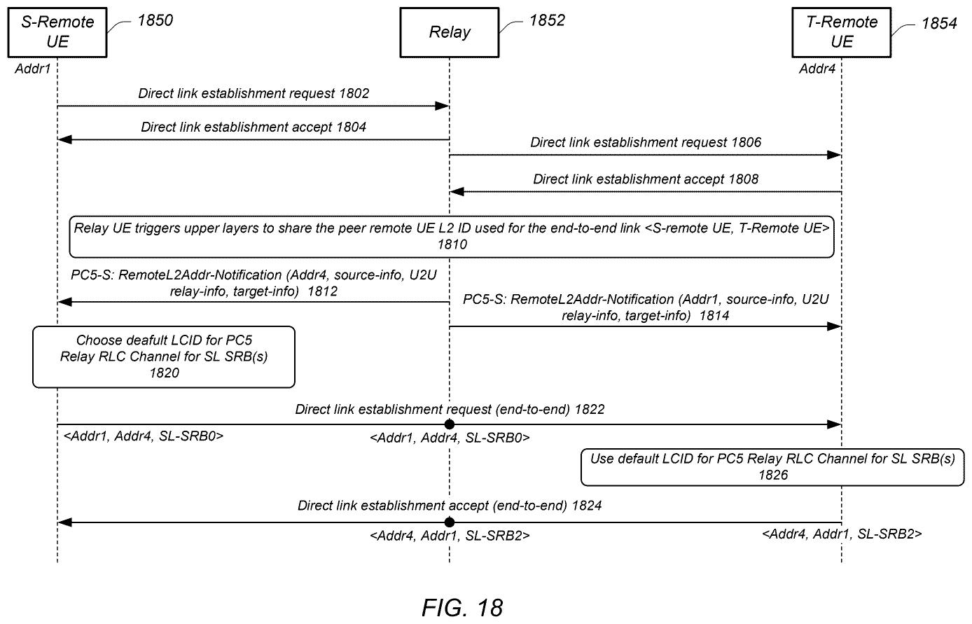

FIG. 18 shows a fifth exemplary timing diagram illustrating signaling flow details for establishing a direct end-to-end Layer 2 PC5 link between two remote UEs via a relay UE, according to some embodiments. The timing diagram illustrates one exemplary combination of Solution 5 and Solution 7-1.

A direct PC5 link may be established between remote UE 1850 and relay UE 1852 (via 1802, 1804), and between relay UE 1852 and remote UE 1854 (via 1806, 1808). The relay UE 1852 may trigger upper layers to share the peer remote UE L2 ID used for the end-to-end link PC5 link between remote UE 1850 and remote UE 1854 (1810). When the upper layer has clearly identified the end-to-end link context (e.g., Addr1+Addr4), the lower layer procedures may use these two addresses to identify the end-to-end PC5 link between remote UE 1850 and remote UE 1854. In some embodiments, new PC5-S signaling (e.g., called “RemoteL2Addr-Notification”) may be used by the relay 1852 to share the address of remote UE 1854 (Addr4 in this case) with remote UE 1850 (1812), and similarly share the address of remote UE 1850 (Addr1 in this case) with remote UE 1854 (1814). Once the respective addresses have been shared by relay UE 1852, the default LCID for PC5 relay RLC channel for SL SRB(s) may be chosen (1820) and the direct link establishment request for the end-to-end PC5 link between remote UE 1850 and remote UE 1854 may be transmitted by remote UE 1850, with the SRAP header carrying the respective addresses Addr1 and Addr4 representative of the end-to-end link (1822). The default LCID for PC5 relay RLC channel for SL SRB(s) may be chosen (1826), and the direct end-to-end PC5 link between remote UE 1850 and remote UE 1854 using Addr1 and Addr4 may be thus established, as confirmed via accept message 1824.

### Considerations for Solution 7-1

A new LCID may be defined in clause “6.2.4 MAC subheader for SL-SCH” of the 3GPP TS 38.321 specification. For example, LCID 55 may be defined to be used for the sidelink control channel (SCCH) to carry PC5-S messages delivered via SL-U2U-RLC as specified in TS 38.331.

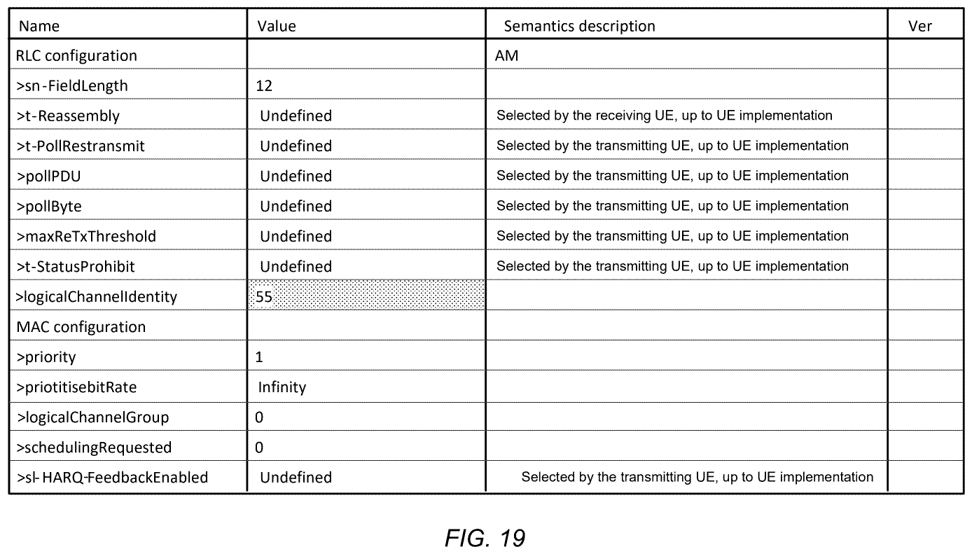

Configuration details for SL-U2U-RLC may be defined in the 3GPP TS 38.331 specification subclause 9.1.1 (fixed) or 9.2.4 (default, but allowing reconfiguration). RLC acknowledge mode (AM) may be used to provide better reliability of the default PC5 relay RLC Channels, as illustrated in the exemplary table shown in FIG. 19.

The use of default SL-U2U-RLC may be defined in the 3GPP TS 38.331 specification. If a fixed SL-U2U-RLC is not to be reconfigured with a different configuration and a different LCID, then it may be used to differentiate end-to-end SL-SRB and SL-DRB. For example, when bearer ID=1 in an SRAP PDU, if it is only on SL-U2U-RLC then it is SL-SRB1, not SL-DRB1. Otherwise, it is SL-DRB1.

### Triggering Conditions for RRC Procedure

As discussed above, the RRC Reconfiguration Sidelink procedure (“RRCReconfigurationSidelink”) may be used in certain U2U relay cases to configure L2 ID (or local ID) and the PC5 Relay RLC channel.

Possible triggering conditions for this procedure for the U2U relay may include:
Add/Modify/Release the configuration of PC5 Relay RLC channel for end-to-end SL SRB(s) and SRAP mapping,
Add/Modify/Release the configuration of PC5 Relay RLC channel for end-to-end SL DRB(s) and SRAP mapping:
   e.g., upper layer PC5-S signaling for end-to-end link has stopped some end-to-end PC5 QoS flows,
   e.g., upper layer has released/deleted one of the end-to-end links,
   e.g., when one of the PC5 hops is broken (SL RLF) and the relay UE or the remote UE needs to release the unnecessary SRAP mapping,
   e.g., after PC5 link is set up in a PC5 hop used for the U2U relay UE,
   e.g., after receiving a PC5 Relay RLC channel configuration from a base station,
Add/Modify/Release allocated Local ID in need of sharing with other UEs (relay UE or remote UE), and
When L2 address of peer remote UE is to be shared with a remote UE.

### Example Method of SL/PC5 Communications Between Remote Devices via a Relay Device

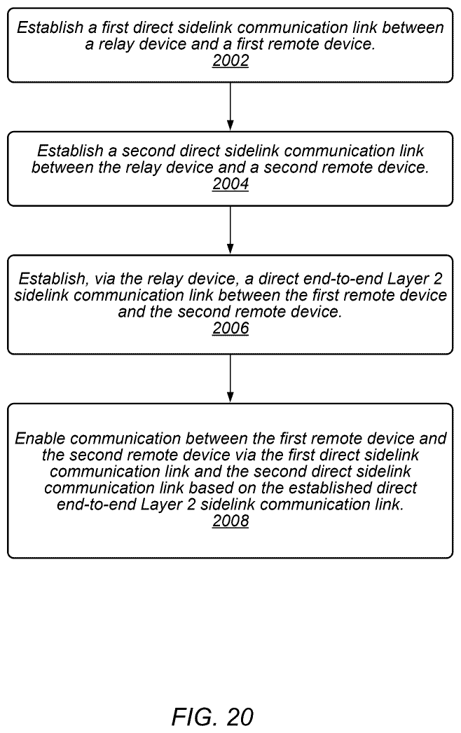

FIG. 20 shows an exemplary flow diagram illustrating sidelink communications between two remote devices via a relay device, according to some embodiments. A first direct sidelink communication link may be established between a relay device and a first remote device (2002). A second direct sidelink communication link may also be established between a relay device and a second remote device (2004). The relay device may assist in establishing a direct end-to-end Layer 2 sidelink communication link between the first remote device and the second remote device (2006). In other words, the direct end-to-end Layer 2 sidelink communication link between the first remote device and the second remote device may be established via the relay device. Communication may then be enabled between the first remote device and the second remote device via the first direct sidelink communication link and the second direct sidelink communication link based on the established direct end-to-end Layer 2 sidelink communication link (2008).

### Various Embodiments

In some embodiments, a relay device may include radio circuitry to transmit and receive radio frequency (RF) signals for wireless communications of the relay device, and may further include a processor interoperating with the radio circuitry to: assist in establishing a first direct sidelink communication link between the relay device and a first remote device, assist in establishing a second direct sidelink communication link between the relay device and a second remote device, and assist in establishing a direct end-to-end Layer 2 sidelink communication link between the first remote device and the second remote device. Communication may then be enabled between the first remote device and the second remote device via the first direct sidelink communication link and the second direct sidelink communication link based on the established direct end-to-end Layer 2 sidelink communication link.

In some embodiments, an apparatus may include a processor configured to cause a relay device to assist in establishing a first direct sidelink communication link between the relay device and a first remote device, assist in establishing a second direct sidelink communication link between the relay device and a second remote device, and assist in establishing a direct end-to-end Layer 2 sidelink communication link between the first remote device and the second remote device. Communication may then be enabled between the first remote device and the second remote device via the first direct sidelink communication link and the second direct sidelink communication link based on the established direct end-to-end Layer 2 sidelink communication link.

In some embodiments, a non-transitory memory element may store instructions, which, when executed, may cause a relay device to assist in establishing a first direct sidelink communication link between the relay device and a first remote device, assist in establishing a second direct sidelink communication link between the relay device and a second remote device, and assist in establishing a direct end-to-end Layer 2 sidelink communication link between the first remote device and the second remote device. Communication may then be enabled between the first remote device and the second remote device via the first direct sidelink communication link and the second direct sidelink communication link based on the established direct end-to-end Layer 2 sidelink communication link.

In some embodiments, a remote device may include radio circuitry to transmit and receive radio frequency (RF) signals for wireless communications of the remote device, and may further include a processor interoperating with the radio circuitry to: assist in establishing a first direct sidelink communication link between the remote device and a relay device, assist in establishing a direct end-to-end Layer 2 sidelink communication link between the remote device and a second remote device, The first remote device may then communicate, based on the established direct end-to-end Layer 2 sidelink communication link, with the second remote device via the first direct sidelink communication link and further via a second direct sidelink communication link established between the relay device and the second remote device.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

Embodiments of the present invention may be realized in any of various forms. For example, in some embodiments, the present invention may be realized as a computer-implemented method, a computer-readable memory medium, or a computer system. In other embodiments, the present invention may be realized using one or more custom-designed hardware devices such as ASICs. In other embodiments, the present invention may be realized using one or more programmable hardware elements such as FPGAs.

In some embodiments, a non-transitory computer-readable memory medium (e.g., a non-transitory memory element) may be configured so that it stores program instructions and/or data, where the program instructions, if executed by a computer system, cause the computer system to perform a method, e.g., any of a method embodiments described herein, or, any combination of the method embodiments described herein, or, any subset of any of the method embodiments described herein, or, any combination of such subsets.

In some embodiments, a device (e.g., a UE) may be configured to include a processor (or a set of processors) and a memory medium (or memory element), where the memory medium stores program instructions, where the processor is configured to read and execute the program instructions from the memory medium, where the program instructions are executable to implement any of the various method embodiments described herein (or, any combination of the method embodiments described herein, or, any subset of any of the method embodiments described herein, or, any combination of such subsets). The device may be realized in any of various forms.

Although the embodiments above have been described in considerable detail, numerous variations and modifications will become apparent to those skilled in the art once the above disclosure is fully appreciated. It is intended that the following claims be interpreted to embrace all such variations and modifications.

1. A method for wireless communications, the method comprising:
establishing a first direct sidelink communication link between a relay device and a first remote device;
establishing a second direct sidelink communication link between the relay device and a second remote device;
establishing, via the relay device, a direct end-to-end Layer 2 sidelink communication link between the first remote device and the second remote device; and
enabling communications between the first remote device and the second remote device via the first direct sidelink communication link and the second direct sidelink communication link based on the established direct end-to-end Layer 2 sidelink communication link.

2. The method of claim 1, wherein establishing the direct end-to-end Layer 2 sidelink communication link uses at least one of:
one or more local identifiers (IDs) established to specifically identify the direct end-to-end Layer 2 sidelink communication link;
one or more Layer 2 IDs to identify the direct end-to-end Layer 2 sidelink communication link, wherein the Layer 2 IDs are also respectively used by the first remote device and the second remote device to conduct sidelink communications with the relay device; or one or more Layer 2 IDs defined by upper layers for specifically identifying the direct end-to-end Layer 2 sidelink communication link.

3. The method of claim 1, wherein establishing the direct end-to-end Layer 2 sidelink communication link comprises:
allocating, by the relay device, a single local identifier (ID) identifying the direct end-to-end Layer 2 sidelink communication link; and
sharing, by the relay device, the single local ID with the first remote device and the second remote device.

4. The method of claim 1, wherein establishing the direct end-to-end Layer 2 sidelink communication link comprises:
allocating, by the relay device, a first local identifier (ID) representing the first remote device and a second local ID representing the second remote device, wherein the first local ID and the second local ID together identify the direct end-to-end Layer 2 sidelink communication link; and
sharing, by the relay device, the first local ID and the second local ID with the first remote device and the second remote device.

5. The method of claim 1, wherein establishing the direct end-to-end Layer 2 sidelink communication link comprises:
allocating, by the first remote device, a first local identifier (ID) the direct end-to-end Layer 2 sidelink communication link for a first sidelink hop between the first remote device and the relay device; and
allocating, by the relay device, a second local ID the direct end-to-end Layer 2 sidelink communication link for a second sidelink hop between the relay device and the second remote device.

6. The method of claim 1, wherein establishing the direct end-to-end Layer 2 sidelink communication link comprises:
sharing, by the relay device
through first sidelink radio resource control (RRC) signaling, a first Layer 2 address of the first remote device with the second remote device, and
through second sidelink RRC signaling, a second Layer 2 address of the second remote device with the first remote device;
wherein the first Layer 2 address and the second Layer 2 address together identify the direct end-to-end Layer 2 sidelink communication link; and
wherein the first remote device also uses the first Layer 2 address for sidelink communications with the relay device, and wherein the second remote device also uses the second Layer 2 address for sidelink communications with the relay device.

7. The method of claim 1, wherein establishing the direct end-to-end Layer sidelink communication link comprises:
receiving, by the relay device from the first remote device, a direct end-to-end link establishment request comprising a sidelink relay adaptation protocol (SRAP) header that contains an indication that the first remote device cannot identify the direct end-to-end Layer 2 sidelink communication link; and
updating, by the relay device, the SRAP header with one or more identifiers identifying the direct end-to-end Layer 2 sidelink communication link; and
forwarding the request with the updated SRAP header to the second remote device.

8. The method of claim 7, wherein the indication that the first remote device cannot identify the direct end-to-end Layer 2 sidelink communication link comprises:
a source device identifier (ID) identifying the first remote device;
a special target device ID indicating that a required target device ID associated with the direct end-to-end Layer 2 sidelink communication link is unknown to the first remote device; and
a bearer ID field indicating that the request is an end-to-end sidelink signal radio bearer 0 (SL-SRB0) message;
wherein the source device ID and the required target device ID together identify the direct end-to-end Layer 2 sidelink communication link.

9. The method of claim 7, further comprising:
receiving the request in an SRAP protocol data unit (PDU); and
determining, based at least on a bearer identifier (ID) field in the SRAP header indicating a sidelink signal radio bearer 0 (SL-SRB 0 ), that the SRAP PDU contains a message aimed at establishing a pending direct end-to-end Layer 2 sidelink communication link;
wherein updating the SRAP header comprises updating the SRAP header to include a target device ID identifying the second remote device.

10. The method of claim 1, wherein establishing the direct end-to-end Layer sidelink communication link comprises:
triggering, by the relay device, upper layers to share
a first Layer 2 identifier (ID) that identifies the first remote device, and
a second Layer 2 ID that identifies the second remote device; and
sharing, by the relay device,
via a first sidelink-signaling-protocol-stack (PC5-S) procedure with the first remote device, the second Layer 2 ID, and
via a second PC5-S procedure with the second remote device, the first Layer 2 ID;
wherein the first layer 2 ID and the second Layer 2 ID together identify the direct end-to-end Layer 2 sidelink communication link; and
wherein the first remote device also uses the first Layer 2 ID for sidelink communications with the relay device, and wherein the second remote device also uses the second Layer 2 ID for sidelink communications with the relay device.

11. The method of claim 1, wherein establishing the direct end-to-end Layer sidelink communication link comprises:
sharing, by the relay device,
via a first sidelink-signaling-protocol-stack (PC5-S) procedure with the first remote device, a second Layer 2 ID, and
via a second PC5-S procedure with the second remote device, a first Layer 2 ID;
wherein the first Layer 2 ID and the second Layer 2 ID are defined by upper layers specifically for the direct end-to-end Layer 2 sidelink communication link.

12. The method of claim 1, further comprising:
configuring sidelink relay radio link control (RLC) channel support for end-to-end sidelink-signaling-protocol-stack (PC5-S) procedures used in establishing the direct end-to-end Layer 2 sidelink communication link.

13. The method of claim 12, wherein configuring the sidelink RLC channel support comprises:
using a single default configuration for sidelink signal radio bearers (SL-SRBs) with fixed default logical channel identifiers (LCIDs) in the first direct sidelink communication link and in the second direct sidelink communication link.

14. The method of claim 12, wherein configuring the sidelink RLC channel support comprises:
configuring, by the relay device via respective sidelink radio resource control (RRC) signaling, sidelink relay RLC channels to support end-to-end sidelink signal radio bearers (SL-SRBs) in the first direct sidelink communication link and in the second direct sidelink communication link.

15. The method of claim 12, wherein configuring the sidelink RLC channel support comprises:
configuring, by the first remote device via first sidelink radio resource control (RRC) signaling, a first sidelink RLC channel used in the first direct sidelink communication link; and
configuring, by the first remote device via second sidelink RRC signaling, a second sidelink RLC channel used in the second direct sidelink communication link.

16. The method of claim 1, wherein establishing the direct end-to-end Layer 2 sidelink communication link comprises using one or more sidelink radio resource control (RRC) procedures, wherein the one or more sidelink radio resource control (RRC) procedures take place prior to initiating establishment of the direct end-to-end Layer 2 sidelink communication link.

17. The method of claim 1, wherein establishing the direct end-to-end Layer 2 sidelink communication link comprises transmitting, by the first remote device, a request to initiate establishment of the direct end-to-end Layer 2 sidelink communication link.

18. The method of claim 17, wherein establishing the direct end-to-end Layer 2 sidelink communication link comprises:
transmitting the request subsequent to allocating one or more identifiers that identify the direct end-to-end Layer 2 sidelink communication link between the first remote device and the second remote device.

19. An apparatus comprising:
a processor configured to cause a relay device to:
assist in establishing a first direct sidelink communication link between the relay device and a first remote device;
assist in establishing a second direct sidelink communication link between the relay device and a second remote device; and
assist in establishing a direct end-to-end Layer 2 sidelink communication link between the first remote device and the second remote device;
wherein communication between the first remote device and the second remote device via the first direct sidelink communication link and the second direct sidelink communication link is based on the established direct end-to-end Layer 2 sidelink communication link.

20. A relay device comprising:
radio circuitry configured to transmit and receive radio frequency (RF) signals for wireless communications of the relay device; and
a processor communicatively coupled to the radio circuitry and configured to interoperate with the radio circuitry to:
assist in establishing a first direct sidelink communication link between the relay device and a first remote device;
assist in establishing a second direct sidelink communication link between the relay device and a second remote device; and
assist in establishing a direct end-to-end Layer 2 sidelink communication link between the first remote device and the second remote device;
wherein communication between the first remote device and the second remote device via the first direct sidelink communication link and the second direct sidelink communication link is based on the established direct end-to-end Layer 2 sidelink communication link.

21-22. (canceled)
